(19) United States
(12) Patent Application Publication
(10) Pub. No.: US 2005/0222892 A1
(43) Pub. Date: Oct. 6, 2005

(54) Strategies for managing recommendations

(75) Inventors: Michael J. Sutherland, Hartford, CT (US); Shital B. Joshi, New York, NY (US); Timothy C. Heinze, Simsbury, CT (US)

Correspondence Address: LEE & HAYES, PLLC, 421 W. RIVERSIDE AVE, STE 500, SPOKANE, WA, 99201, US

(73) Assignee: ERC-IP LLC, Overland Park, KS (US)

(21) Appl. No.: 10/815,099

(22) Filed: Mar. 30, 2004

(51) Int. Cl. G06F 17/60

(52) U.S. Cl. 705/10

(57) ABSTRACT

A web-enabled system and associated techniques are described for managing recommendation information, such as recommendation information pertaining to property loss prevention provisions. The system provides a graphical user interface for entering the recommendation information according to a well-defined process flow. The system also provides notification functionality for sending notification messages to participants upon the occurrence of various triggering events. The system also includes provisions for providing a historical sequence of recommendation entries via the system, and for filtering, sorting, printing, and/or exporting the recommendation information. The system also provides customization functionality for tailoring certain aspects of the system to suit different business environments.

### RELATED APPLICATIONS

This application is related to the following copending and commonly assigned U.S. applications, which are incorporated herein by reference in their respective entireties: U.S. Ser. No. 10/085,497, filed on Feb. 26, 2002, entitled “Risk Management Information Interface System and Associated Methods”; U.S. Non-Provisional Ser. No. 10/______, filed ______, entitled “Risk Management Information Interface System and Associated Methods” (Attorney Docket No. 401241); and U.S. Non-Provisional Ser. No. 10/411,912, filed on Apr. 12, 2003, entitled “Risk Management Information Interface System and Associated Methods.”

### TECHNICAL FIELD

This invention relates to strategies for managing recommendations, and, in a more particular implementation, to computer-related strategies for managing recommendations pertaining to a business.

### BACKGROUND

Businesses periodically review their operations (e.g., their procedures, facilities, etc.) to ensure that these operations satisfy prescribed requirements. For instance, in one exemplary case, a business may periodically examine its operations to ensure that these operations provide adequate safeguards to protect against property loss (such as property loss due to fire or other hazards). If safeguards are not in place, the business may develop and implement recommendations designed to reduce its vulnerability to property loss. In another exemplary case, a business may also periodically examine its compliance with relevant regulatory standards (e.g., various health-related standards) and develop appropriate recommendations to address any shortcomings it detects. In another exemplary case, a business may also review its operations with an eye to simply improving its profitability, quality of goods and services produced (of a tangible and/or intangible nature), and/or efficiency. In general, at any given time, a successful and responsible business can be expected to be critically examining its operations, and using any insight gained in such examination to improve the business.

However, the complexity of modem businesses often makes the development and implementation of recommendations a challenging task. For instance, many businesses rely on sophisticated procedures and systems to produce their products. Further, large corporate entities typically include many different plants that employ a large number of workers having interrelated roles. It therefore becomes a complex task to first gain sufficient familiarity with the operational characteristics of such businesses and their associated deficiencies. It is likewise a complex task to determine how such business operations might be improved, and how such improvements might be efficiently carried out within the businesses. To meet these challenges, businesses may employ individuals who are specifically tasked with the responsibility of studying the business operations and generating recommendations to improve the operations with some identified goal in mind. Alternatively, or in addition, the businesses may hire outside consultants to assist the businesses in analyzing their operations and making recommendations.

In general, the successful implementation of a recommendation generally includes several tasks, such as an initial investigation of the business operation, the development of a recommendation, and the implementation of such a recommendation. Ad hoc approaches to these tasks suffer from various inefficiencies. For instance, ad hoc approaches may fail to clearly delineate the roles of the individuals assigned to these tasks, resulting in the possible duplication of some tasks and the omission of other tasks. Further ad hoc approaches may fail to provide adequate channels of communication among the individuals assigned to these tasks. For instance, an investigator may examine a business operation and generate various findings. The investigator may record his or her findings in a written report, and then archive the report in a filing system, e.g., by manually keying this written report into the filing system. However, there is no assurance that this report has been accurately input into the filing system, and there is no assurance that it can be subsequently retrieved and acted on in an efficient and reliable manner by others (who might not even be aware of the existence of the report and/or how to access it).

Further, once decisions are made, there is no mechanism to ensure that these decisions are reliably and accurately propagated to the appropriate individuals in the business who will carry them out. And even if these recommendations are propagated to the appropriate individuals, there is a risk that these individuals (and, in turn, the managers entrusted with overseeing these individuals) may simply put these tasks aside and eventually forget about these tasks. Needless to say, in the area of loss prevention, the failure to timely and efficiently process and act on recommendations can have catastrophic effects for the business. And such problems are only compounded in modern business operations which may involve many participants performing complex and interrelated tasks, where many improvement efforts may be pending at the same time in different stages of development.

Accordingly, there is an exemplary need to provide techniques and systems for more efficiently managing recommendations.

### SUMMARY

According to one exemplary implementation, a method is described for managing recommendations using a computer system. The method includes: (a) receiving survey information from an individual serving a fist role pertaining to an aspect of an organizational entity, the survey information including at least one recommendation; (b) storing the survey information; (c) receiving, via a user interface, first recommendation information from an individual serving a second role, the first recommendation information being based on the survey information received from the individual serving the first role; (d) storing the first recommendation information; (e) receiving, via the user interface, second recommendation information from an individual serving a third role, the second recommendation information being based on the first recommendation information received from the individual serving the second role; (f) storing the second recommendation information; and (g) addressing the above-identified at least one recommendation based on the first and second recommendation information.

According to another exemplary feature, the survey information, the first recommendation information, and the second recommendation are stored together in a central database provided by the computer system.

Additional implementations and features will be described in the following.

### BRIEF DESCRIPTION OF THE DRAWINGS

FIG. 1 shows an exemplary system for managing recommendations in an organization.

FIG. 2 shows an exemplary computer device for interacting with the system of FIG. 1.

FIGS. 3-5 collectively show an exemplary procedure for managing recommendations using the system of FIG. 1.

FIGS. 6-22 show a series of exemplary user interface presentations that enable users to interact with the system of FIG. 1.

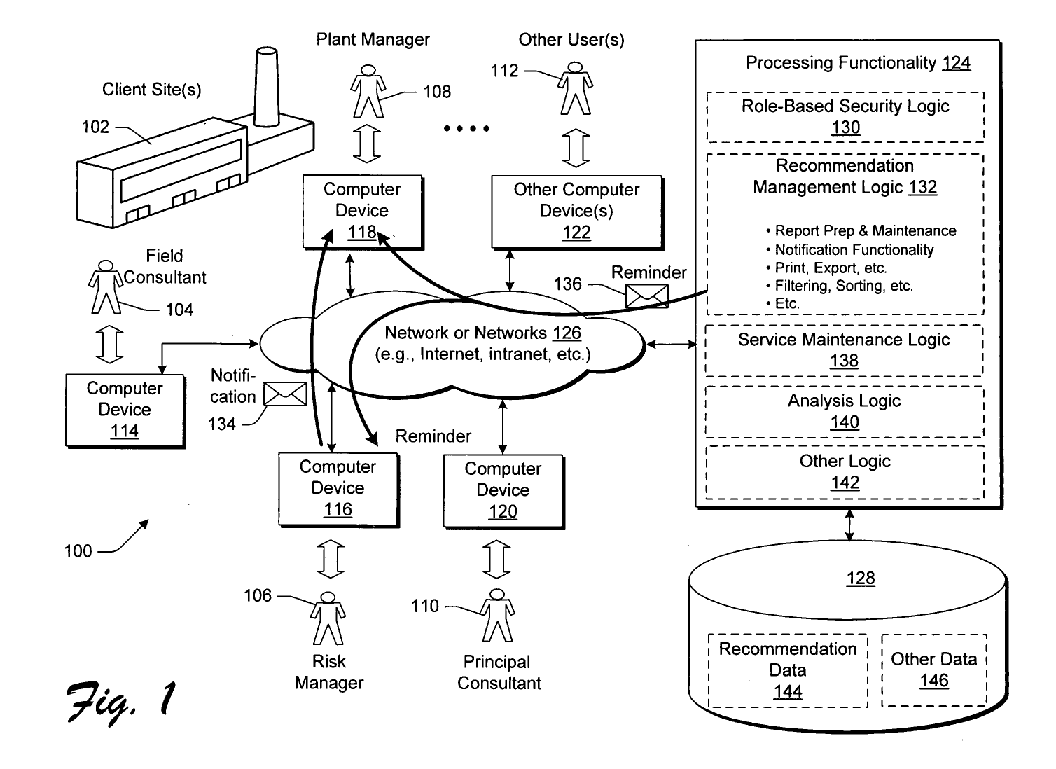

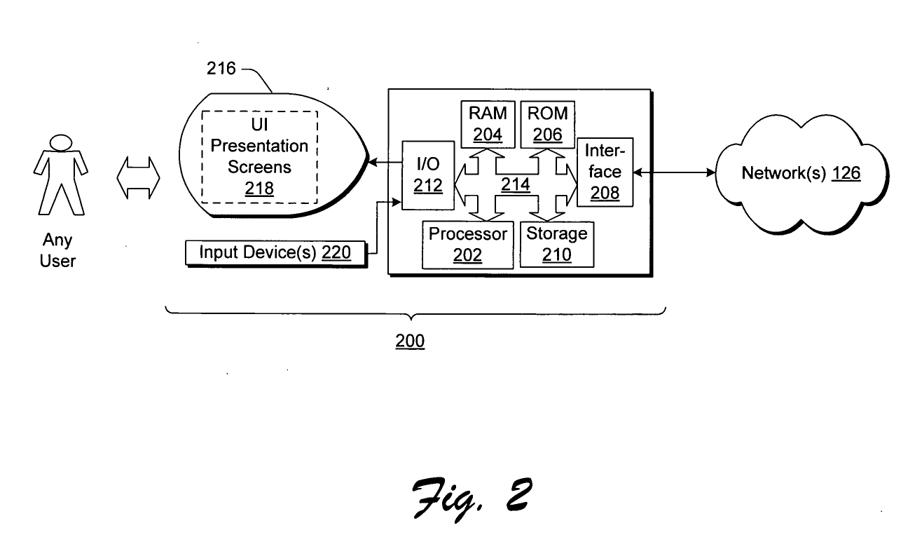

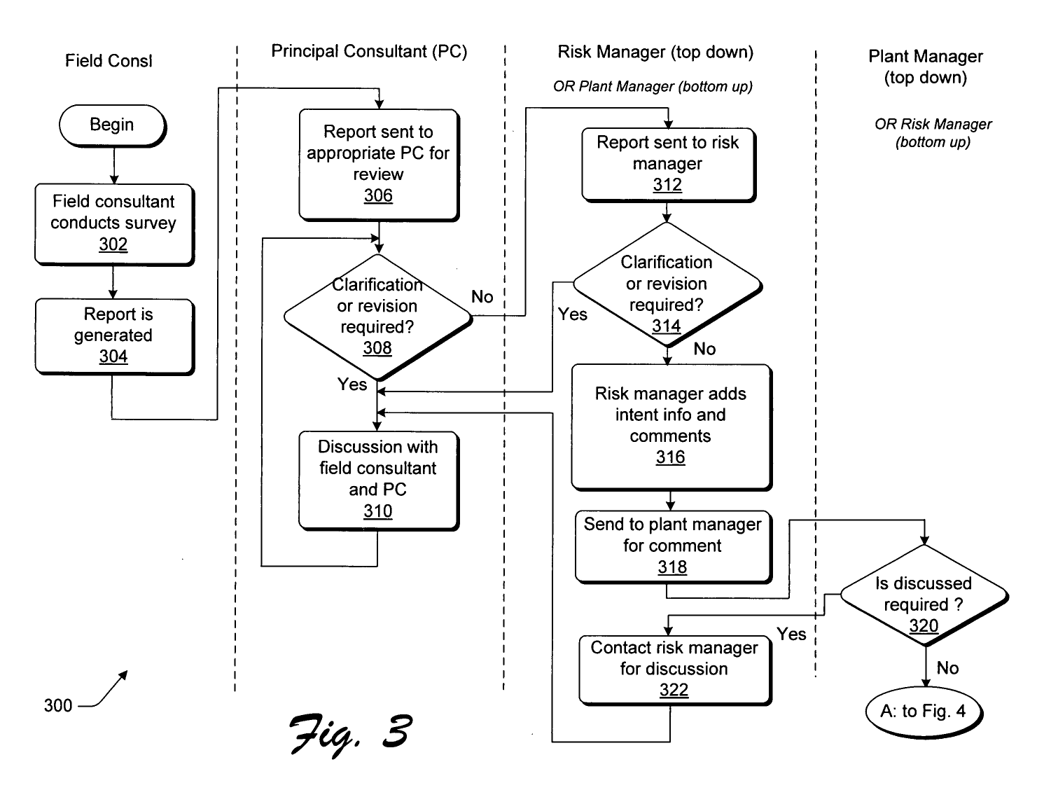

The same numbers are used throughout the disclosure and figures to reference like components and features. Series 100 numbers refer to features originally found in FIG. 1, series 200 numbers refer to features originally found in FIG. 2, series 300 numbers refer to features originally found in FIG. 3, and so on.

### DETAILED DESCRIPTION

Techniques and systems for managing recommendations are described herein. The recommendations pertain to any aspect of any kind of entity. For instance, in one exemplary case, the recommendations may pertain to suggestions directed at reducing the risk of property loss in an organization. Alternatively, or in addition, the recommendations may pertain to suggestions directed at improving compliance with governmental regulations (such as OSHA guidelines, or other health-related standards). Alternatively, or in addition, the recommendations may pertain to suggestions designed to improve any definable metric of an organization, such as its profitability, efficiency, quality and/or quantity of assets produced, and so on. For example, the recommendations may provide advice on how a business might improve the efficiency of an assembly line used to produce tangible goods. But the recommendations can also target the intangible assets of the business; for example, the recommendations may provide advice regarding how a business might improve brand recognition for the goods that its assembly line produces.

The term “entity” and “organization” should likewise be construed broadly herein. The term “entity” or “organization” may pertain to any kind of business, such as a single-person venture, a partnership or corporation for producing any kind of service or product, and so forth. To name but a few exemplary applications, the business may provide any kind of consumer goods, any kind of manufacturing goods, various kinds of computer-related services, various kinds of financial services, various kinds of marketing services, and so on. Alternatively, or in addition, the organization may refer to a non-commercial entity, such as a government organization, an academic organization, a charitable organization, and so on.

Nevertheless, to facilitate discussion, the below discussion is framed principally in the exemplary context of the generation of recommendations for a business that produces a tangible (and/or intangible) goods and/or services of some kind. In this context, the business may comprise a corporation having one or more manufacturing plants. In this application, the recommendations specifically pertain to loss prevention provisions. That is, in this exemplary application, the recommendations pertain to actions that may be taken by the business to help reduce the risk of asset loss, such as the loss of buildings, equipment, etc. to fire or other hazard. But, again, this application is merely illustrative. The recommendations can be applied to any business environment, such those businesses which “produce” various kinds of financial products. In any of these cases, the techniques and systems described herein provide a structured and efficient framework for managing any kind of recommendations from the initial investigatory stages of the recommendations to the completed implementation of the recommendations. As indicated above, the recommendations can pertain to safety related issues, government compliance related issues, product and service improvement related issues (pertaining to tangible and/or intangible assets), and so on.

This disclosure includes the following sections: Section A sets forth an exemplary system for implementing techniques for managing recommendations; Section B sets forth an exemplary technique for managing recommendations using the system described in section A; and Section C sets forth an exemplary series of user interface presentations that enable users to interact with the system described in Section A.

A. Exemplary System

FIG. 1 shows a system 100 for managing recommendations. The recommendations can pertain to suggested safeguards to reduce the risk of asset loss in a business. The business can include multiple plants, such as exemplary plant 102. This plant 102 can be dedicated to the production of any kind of goods or services.

A variety of actors may interact with the system 100 depending on the environment in which the system 100 is applied. In the exemplary environment of FIG. 1, a field consultant 104 (also referred to as a field engineer) may serve the role of examining the plant 102 to determine whether it has satisfactory loss prevention mechanisms and procedures in place. The field consultant 104 may have special training that allows this person to make informed judgments regarding such issues as fire safety, etc. The field consultant 104 may formulate his or her decision in one or more survey reports, which are stored by the system 100. The survey reports may specify recommendations designed to reduce the risk of property loss. One concrete recommendation might be: “Add overhead sprinklers to the boiler room.” As used herein, the term “survey information” broadly refers to any information contained in the survey report, which may include textual descriptions of recommendations and other technical data that captures the field consultant 104's opinions and insight.

A risk manager 106 serves the role of analyzing the survey information generated by the field consultant 104, including any recommendations contained therein. Based on this analysis, the risk manager 106 may generate recommendation information. As used herein, the term “recommendation information” refers to any information that pertains to recommendations, including so-called intent information. More specifically, the intent information can be selected from a set of brief instructions directed to those who will implement the recommendations, such as “Do,” “Do Not Do,” “Consider,” etc. As these instructions effectively express the intent of the risk manager 106, they are referred to herein as “risk manager intent” information or “risk management intent” information. The recommendation information entered by the risk manager 106 can also include commentary regarding the recommendations and associated instructions. The system 100 stores the risk management intent information and accompanying comments.

The risk manager intent information and comments are then made available to others in the business, such as a plant manager 108. The plant manager 108 serves the role of running some aspect of the operation of the plant 102. The plant manager 108 also reviews recommendation information entered by the risk manager 106, namely the risk manager intent information (which captures the brief instructions of the risk manager 106), as well as the risk manager 106's comments. The plant manager 108 is then given the opportunity to enter his or her own recommendation information, which may constitute a reply to the instructions of the risk manager 106. Like the case of the risk manager 104's input, the plant manager 108's input can be selected from a set of brief phrases that capture the intent of the plant manager 108 (and is hence referred to herein as “plant manager intent” information or “plant management intent” information). The plant manager 108 can also enter accompanying comments. The plant management intent information and commentary are then stored in the system 100. The plant manager 108, or other individual, may also be entrusted with the task of specifying a target date associated with the completion of the recommendation's implementation, and then subsequently updating the status of the implementation by entering an appropriate descriptive phrase (such as “Complete,”) into the system 100.

The above-described development of recommendations adopts a so-called “top-down” approach. This is because the risk manager 106 formulates instructions that are then propagated down to the people more closely associated with running the plant 102, such as the plant manager 108. However, it is also possible to develop recommendations using a “bottom-up” approach. In this approach, those more closely associated with the operation of the plant 102 (such as the plant manager 108) inform the risk manager 106 what they plan to do based on their own evaluation of the field consultant 104's report and recommendations contained therein. The risk manager 106 then reviews the resultant plant manager intent information and comments and responds by entering his or her own intent information and comments. The recommendations are then implemented based on the authorization of the risk manager 106.

In yet another approach, no workflow structure is specified (referred to as the “No workflow” approach). In this case, either the risk manager 106 or the plant manager 108 can specify their intent information first.

A principal consultant 110 facilitates the execution of the above-described development of recommendations. The principal consultant 110 performs this task by interacting with the other actors involved in the process, helping to resolve disagreements that may arise, and performing other facilitating tasks. In one exemplary application, the business may procure the services of a professional consulting firm or company, and the principal consultant 110 may represent an employee of that consulting firm or company. In this case, the principal consultant 110 endeavors to determine and meet the needs of the business by interacting with the above-identified individuals within the business. More generally, any of the actors shown in FIG. 1 can be affiliated with one company, or any combination of different companies; the functionality of the system 100 is flexible enough to accommodate different business arrangements and models.

Finally, FIG. 1 generally indicates that one or more other users 112 may be involved in the development of the recommendations. The identity of such other users 112 may vary depending on the business environment in which the system 100 is applied. One exemplary business environment provides access to various corporate users, brokers, etc.

In summary, each of the actors (104-112) shown in FIG. 1 has a different assigned role in the development and implementation of recommendations. But the titles of these actors are otherwise arbitrary and non-limiting. Further, in other implementations, functions assigned to two or more actors can be performed by a single actor. Or functions assigned to a single actor can be broken up and performed by two or more actors. Further information regarding the process flow used to develop recommendations involving the above-identified actors (104-112) is provided in Section B below.

The system 100 itself includes a collection of computer devices (114, 116, 118, 120, . . . 122) coupled to processing functionality 124 via a network or networks 126 (referred to as “network 126” below for brevity). The computer devices (114, . . . 122) can include any kind and any combination of processing devices, such as personal general purpose computers, laptop computers, personal digital assistants (PDAs), various kinds of data entry terminals, and so forth. (FIG. 2, to be discussed below, shows the exemplary makeup of an exemplary computer device).

In one exemplary implementation, the processing functionality 124 can be implemented as a server computer, or a collection of server computers (such as a server farm). A server computer is a computer device with software and/or hardware dedicated to processing and responding to the requests of the computer devices (114, . . . 122). Any kind of server platform can be used, such as server functionality provided by iplanet, produced by Sun Microsystems, Inc., of Santa Clara, Calif., etc. Although shown as localized at a single site for convenience of illustration, certain aspects of the processing functionality 124 can be distributed over plural sites. In additional, certain aspects of the processing functionality 124 can be implemented, in whole or in part, by the individual computer devices (114, . . . 122).

In the exemplary case where the processing functionality 124 is implemented at a central server or servers, this processing functionality 124 can be “owned” and/or administered by the firm or company which provides the consulting services to the business (e.g., the firm or company associated with the principal consultant 110). However, this arrangement is exemplary. The basic functions and features of the system 100 can be owned and administered by any combination of business entities to suit the requirements of particular technical and business environments.

The processing functionality 124 can interact with one or more databases 128. The database 128 can include any collection of physical storage units, representing silicon storage devices, optical storage devices, magnetic storage devices, etc. The database 128 can also include dedicated processing functionality, such as a dedicated server, for maintaining the data stored therein. This dedicated processing functionality can use any kind of storage technique, such as Structured Query Language (SQL). Various known commercial products can be used to implement the database 128, such as various data storage solutions provided by the Oracle Corporation of Redwood Shores, California. The database 128 can be located at a single site, or spread over plural sites in a distributed fashion.

The network 126 can be implemented using a wide area network (WAN) governed by the Transmission Control Protocol and the Internet Protocol (TCP/IP). For instance, this network 126 can be implemented using the Internet. Alternatively, or in addition, the network 126 can be implemented using an intra-company intranet; for instance, the intranet can interconnect a collection of computer devices used by the business, and this intranet can then couple to the Internet via firewall security provisions (not shown). The network 126 can alternatively be implemented using other kinds and combinations of networks, such as LAN networks, Ethernet networks, and so on. In any case, the network 126 can include any combination of hardwired links, wireless links, gateways, routers, name servers, and so on (although not shown). The individual computer devices (114, . . . 122) can couple to the network via broadband connection, modem coupling, DSL coupling, or other kind of coupling.

The coupling of computer devices (114, . . . 122) to the processing functionality 124 forms a client-server mode of network interchange and processing. However, other models can be used, such as a peer to peer (P2P) model.

FIG. 1 illustrates some of the functions that the system 100 can provide by showing different blocks of “logic” within the processing functionality 124. These logic blocks can be implemented at a central server (or servers). Alternatively, or in addition, certain aspects of the logic blocks can be implemented, in whole or in part, locally by the individual computer devices (114, . . . 122).

Generally, the term “logic” or “module” as used herein represents software, firmware, or a combination of software and firmware. For instance, in the case of a software implementation, the term “logic” or “module” represents program code that performs specified tasks when executed on a processing device or devices (e.g., CPU or CPUs). The program code can be stored in one or more computer readable memory devices. The illustrated separation of logic and modules into distinct units may reflect an actual physical grouping and allocation of such software and/or hardware, or can correspond to a conceptual allocation of different tasks performed by a single software program and/or hardware unit. The illustrated logic and modules can be located at a single site (e.g., as implemented by a single processing device), or can be distributed over plural locations.

A role-based security logic module 130 generally performs the task of granting and denying access to the resources of the processing functionality 124. That is, if the processing functionality 124 is implemented as Internet-accessible resources, the role-based security logic module 130 serves the role of granting access to authorized users and denying access to unauthorized users. This gate keeping function can be performed by requiring each user to input a user name and a password. The role-based security logic module 130 then checks the entered user name and password against a stored list of authorized users; if the username and password match an entry on this list, then access to the processing functionality 124's resources is permitted.

More specifically, different users of the system 100 may have different roles within the business or within the consulting firm that is interacting with the business. These different roles entitle these users to access and interact with different respective security levels and associated resources maintained by the processing functionality 124. To provide this role-based selective access, the role-based security logic module 130 can determine a user's access privileges when the user logs into the processing functionality 124, e.g., by using the user's entered identity information as an index to determine what access privilege information governs the user's interaction with the processing functionality 124. The role-based security logic module 130 uses this access privilege information to define the types of user interface presentations that the user is permitted to view.

The role-based security logic module 130 also uses this access privilege information to define whether the user can retrieve individual resources. Resources can be made available or unavailable based on a comparison of the user's access privilege information with security-related fields associated with the resources. Thus, the selective access to information can function in a relatively fine-grained manner by selectively granting and denying access to individual documents maintained by the processing functionality 124. In general, users who oversee the operation of several plants within the business are globally granted access to the resources associated with those several plants. But users who carry out responsibilities that are confined to a single plant may only be granted access to resources associated with that single plant. In other words, security levels can be assigned on the basis of need. A user who is assigned tasks that require the user to view and edit certain fields of information is granted access to those fields. But if the user's job responsibilities do not require interaction with certain fields, the role-based security logic module 130 may be configured to preclude this user from viewing and/or editing those fields.

Recommendation management logic module 132 handles the core of the tasks associated with managing recommendations. For instance, this logic module 132 can coordinate the collection of survey information from the field consultant 104 and can then coordinate the interaction between the risk manager 106 and the plant manager 108. It performs this interaction via a series of user interface presentations that it provides to the managers (106, 108) at display monitors (not shown) associated with respective computer devices (114, . . . 122). More specifically, the recommendation management logic module 132 coordinates the collection of recommendation information (e.g., intent information and comments, etc.) via a so-called recommendation response report. This recommendation response report includes entry fields allocated to receiving the risk manager 106's recommendation information and other entry fields allocated to receiving the plant manager 108's recommendation information. Section C below provides additional details regarding the recommendation response report.

The recommendation management logic module 132 also provides functionality for sending various notifications to users of the system 100. For instance, in the top-down mode of process flow, after the risk manager 106 enters his or her intent information and comments, the recommendation management logic module 132 facilitates the transmission of a notification (e.g., an email message) from the risk manager 106 to the plant manager 108. This notification alerts the plant manager 108 to the fact that recommendation information has been entered by the risk manager 106 (and that this recommendation information affects plant operations that the plant manager 108 oversees). The plant manager 108 responds by providing his or her own recommendation information (e.g., comprising intent information, comments, etc.). The plant manager 108, or other appropriate individual, also specifies a target date when the recommendations are to be implemented within the plant 102.

However, if the plant manager 108 fails to input information into these fields, then the recommendation management logic module 132 can be configured to automatically send one or more reminder notifications, such as reminder emails. For instance, a first reminder notification can be sent if the plant manager 118 has not responded within a first period of time (e.g., 45 days), and a second reminder notification can be sent if the plant manager 108 has not responded within a second period of time (e.g., 60 days). Different environments can provide different rules for these reminder notifications, that is, by specifying the timing at which the notifications are sent out as well as specifying the recipients of the notifications.

After a target date has been specified, the recommendation management logic module 132 can send another series of automatic reminder notifications relative to the target date. For instance, the recommendation management logic module 132 can send a reminder notification when the target date occurs. It can then send another reminder notification a predetermined time following the target date (e.g., 30 days after the target date), that is, providing that the plant manager 108 has not entered status information into the system 100 which indicates that the implementation of the recommendation has been completed.

FIG. 1 illustrates the transmission of notifications by showing exemplary notifications 134 and 136 (which can be implemented as email notifications). Notification 134 represents the transmission of an email from the risk manager 106 to the plant manager 108 after the risk manager has finished entering recommendation information (e.g., intent information and comments). If a bottom-up mode of process flow is employed, then the plant manager 108 would send the notification 134 to the risk manager 106. Reminder notification 136 represents the automatic transmission of an email to the plant manager 108 and/or the risk manager 106 (and any other appropriate personnel). These two notifications (134, 136) are representative of the notification functionality provided by the system 100. More generally stated, any computer device can transmit a notification (e.g., an email) to another computer device, and any computer device can receive a notification from another computer device. Further, any computer device can receive a notification that has been automatically sent by the recommendation management logic module 132.

The recommendation management logic module 132 can also perform a number of other tasks associated with the generation and dissemination of recommendation information. For instance, upon command, it can print out recommendation information gleaned from the recommendation response report. It can also export recommendation information in a specified format upon command. It can also filter the recommendation information to cull out recommendation information that meets a specified criterion or criteria. It can also sort the recommendation information based on a specified criterion or criteria. Still other functionality can be provided to process and “package” the recommendation information to suit different business needs.

The processing functionality also includes a service maintenance logic module 138. This logic module 138 allows a user to customize various aspects of the functionality provided by the system 100 (providing that the user is granted authorization by the system 100 to do so). For instance, the service maintenance logic module 138 includes functionality for allowing the user to specify whether the processing flow will be governed by the top-down flow model or the bottom-up flow model, or by the “No workflow” model. As explained above, a top-down model generally involves a person serving an overseeing role logging his or her intent information and comments first, and then prompting another person more closely associated with the plant operation to respond by entering his or her own intent information and comments. The bottom-up model reverses these roles, such that the person “near” the plant operations enters his or her intent information and comments first; then the overseeing person reviews this information and enters their own intent information and comments. In the “No workflow” model, either the risk manager 106 or the plant manager 108 can enter their intent information first.

The service maintenance logic module 138 also allows an authorized user to customize other aspects of the services provided by the processing functionality 124. For instance, a suitably authorized user can specify when reminder notifications should be sent, and to whom they should be sent. The service maintenance logic module 138 also allows an authorized user to customize various “canned” phrases that can be used to express intent information and status information. Still other features can be customized using the service maintenance logic module 132. Insofar as part of the service maintenance logic module 138 allows the user to customize the operation of the recommendation management logic module 132, this part of the service maintenance logic module 138 can alternatively be conceptualized as included within the recommendation management logic module 132 itself.

The processing functionality 124 also includes an analysis logic module 140. This logic module 140 generally represents a suite of tools that can be employed to process information collected using the system 100, such as survey information and recommendation information. The above-identified commonly assigned applications describe several exemplary analysis tools, any of which can be provided by the analysis logic module 140. These tools can include: benchmarking logic for providing risk quality rating at the facility, division, or enterprise levels; charting logic for charting outstanding recommendations; predictive logic for providing forecasts regarding what may happen in the future based on an analysis of historical information; various statistical tools for extracting meaningful information from collected data, and so on.

The logic blocks shown in FIG. 1 are exemplary. The processing functionality 124 can implement a number of other functions, as generally indicated by the logic block identified as “other logic” 142 in FIG. 1.

The database 128 can store the various fields of information collected during the development of recommendations, as well as through other input processes. This information is referred to in FIG. 1 as recommendation data 144. The recommendation data 144 can include various survey information input by the field consultant 104, risk management intent information, risk management comments, plant management intent information, plant management comments, target date information, target date status information, and any other data associated with the recommendation response report and other associated reports. The database 128 can also store a variety of additional information, as generically indicated in FIG. 1 by the data module labeled “other data” 146. Generally, the database 128 can divide the data into various groupings of folders (e.g., corresponding to the metaphor of “file cabinets”), folders (e.g., “binders”), files, fields, and so on. For instance, the database 128 can allocate separate file cabinets to different companies. For each company, the database 128 can allocate separate binders to different facility locations.

FIG. 2 shows the architecture 200 of any one of the computer devices (e.g., 114, 116, 118, 120, . . . 124) shown in FIG. 1. The architecture 200 can correspond to any kind of computer device, such as a personal computer, laptop computer, personal digital assistant (PDA), etc. The computer architecture 200 includes conventional computer hardware, including a processor 202, RAM 204, ROM 206, a communication interface 208 for interacting with a remote entity (such as another computer device or the processing functionality 124 via the network 126), storage 210 (e.g., an optical and/or hard disc storage and associated media interface functionality), and an input/output interface 212 for interacting with various input devices and output devices. The above-mentioned components are coupled together using bus 214.

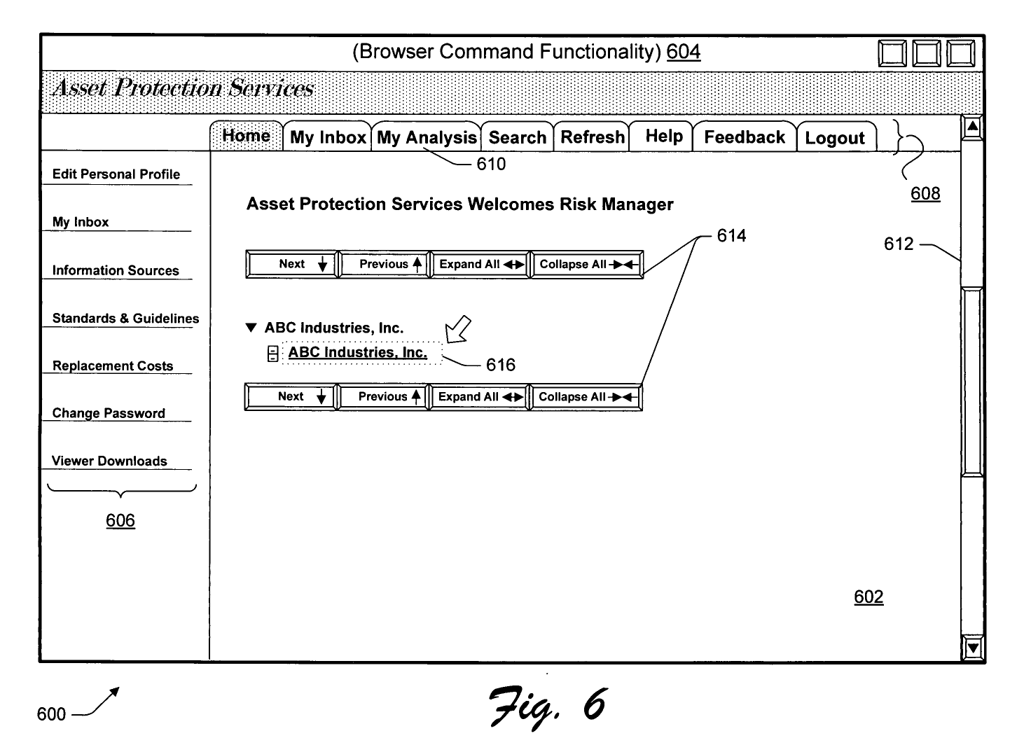

An exemplary output device includes the computer display monitor 216. The computer architecture 200 can be configured, in association with the processing functionality 124, to provide various graphic user interface (GUI) presentations 218 on the computer display monitor 216. These user interface presentations 218 are illustrated in FIGS. 6-22 and described in Section C below. The application logic for providing the user interface presentations 218 can be stored within the computer device architecture 200 (e.g., in the RAM 204, ROM 206, and/or storage 210, etc.), and/or can be stored within the processing functionality 124.

Finally, an input device 220 permits the user to interact with the computer architecture 200 based on information displayed on the computer display monitor 216. The input device 220 can include a keyboard, a mouse device, a joy stick, a data glove input mechanism, throttle type input mechanism, track ball input mechanism, a voice recognition input mechanism, a graphical touch-screen display field, and so on, or any combination of these devices.

The architecture of the processing functionality 124 is not illustrated. But insofar as this functionality is implemented as a server-type computer, it can include the kinds of components shown in FIG. 2, such as RAM, ROM, input device I/O, communication interfaces, processors, buses, storage, and so on.

B. Exemplary Method of Operation

FIGS. 3-5 together show a procedure 300 for managing recommendations using the system 100 of FIG. 1. In general, to facilitate discussion, certain operations are described as constituting distinct steps performed in a certain order. Such implementations are exemplary and non-limiting. Certain steps described herein can be grouped together and performed in a single operation, and certain steps can be performed in an order that differs from the order employed in the examples set forth in this disclosure. Where the steps represent functionality performed by the system 100 (as opposed to manual activity), that functionality can be implemented in hardware, software, or a combination or hardware and software.

To provide a concrete framework for discussion, the procedure 300 pertains to the exemplary application of the system 100 to the prevention of property loss in a business. As indicated in FIG. 1, this environment involves a field consultant 104, risk manager 106, plant manager 108, and principal consultant 110. The steps in the procedure 300 are organized in columns associated with these different actors to indicate that these steps are performed by these respective actors (or are otherwise associated with these actors). More generally, however, the system 100 and associated procedure 300 can be applied to any environment that involves the development and processing of recommendations. Accordingly, the steps shown in procedure 300 can be performed by other actors associated with such other business environments.

Procedure 300 corresponds to the exemplary top-down flow of process steps. As described in Section A, the top-down procedure requires the risk manager 106 to enter recommendation information into the recommendation response report prior to the plant manager 108's entry of recommendation information. However, the procedure 300 can be modified to serve in a bottom-up environment, in which the plant manager 108 enters recommendation information into the recommendation response report prior to the risk manager 106. In the bottom-up approach, the tasks attributed to the risk manager 106 in FIGS. 3-5 can generally be reassigned to plant manager 108, and the tasks attributed to the plant manager 108 can generally be reassigned to the risk manager 106.

To begin with, in step 302 of FIG. 3, the field consultant 104 visits the plant 102 (or other business facility) and examines it to determine whether it satisfies certain criteria. In the concrete example featured here, the field consultant 104 particularly examines the plant 102 to determine whether there are any risks of property loss at the plant 102. For instance, the field consultant 104 can determine whether adequate fire prevention mechanisms and procedures are in place to reduce the risk of loss to fire.

In step 304, the field consultant 104 enters his or her findings into the system 100 to form a survey report. The survey report may contain various identifying information regarding the operations and facilities inspected, various technical data regarding the field consultant 104's findings, various risk reduction recommendations, and other information. An exemplary recommendation might be: “Install overhead sprinklers in the boiler room.” The field consultant 104 can perform step 304 by entering information into the computer device 114, which may comprise a personal computer, a portable data entry device, a laptop computer, and so forth. The processing functionality 124 stores the survey report data in an appropriate location in the database 128 so that it can be later retrieved. The processing functionality 124 can also be configured to automatically extract information from the survey report for inclusion in other reports, such as the recommendation response report. Accordingly, the keystrokes made by the field consultant 104 can ultimately “end up” in various other high level reports, thus eliminating the burdensome and error-prone need of manually extracting and re-keying such data.

In step 306, the field consultant 104's report is sent to the principal consultant 110 (PC) associated with the business. As previously stated, the business may have hired the principal consultant to assist the business in the collection, management, and implementation of recommendation information. The principal consultant 110 can be affiliated with an independent consulting firm or company, or can be an employee of the business itself.

In step 308, the principal consultant 110 determines whether there are any aspects of the field consultant 104's survey report that are ambiguous, incomplete, or otherwise deficient. If so, in step 310, the principal consultant 100 initiates a discussion with the field consultant 114 to rectify the deficiencies. This discussion can take place in a face to face encounter, via telephone, via email, or through other communication channels.

After clarifying the field consultant 104's survey report (if possible), in step 312, the survey report is sent to the risk manager 106 (that is, providing that the flow model has been set up to operate in top-down fashion). As previously described, the risk manager 106 is assigned the role of generally overseeing and coordinating the implementation of risk reduction measures in the business. He or she may be employed by the business or by an “outside” consulting firm or company. In step 314, the risk manager 106 examines the survey report and determines whether it requires clarification or other revision. (Section C below describes exemplary user interface functionality that can be used to view the survey report; in brief, the risk manager 106 can examine a rendition of the survey report itself or a report which contains information extracted from the survey report). If the survey report is not satisfactory, the procedure 300 indicates that further discussion between the principal consultant 110 and the field consultant 104 can take place to attempt to rectify the perceived deficiencies.

If the risk manager 106 is satisfied with the report, then, in step 316, the risk manager 106 enters recommendation information pertaining to the recommendations in the field consultant 104's survey report. This recommendation information specifically can comprise intent information and comments. The intent information provides high level information that reflects what the risk manager 106 decides should be done in response to the field consultant 104's recommendations. For instance, based on the field consultant 104's recommendations, the risk manager 106 may indicate that certain safety provisions, such as overhead sprinklers, should be added to the plant 102 to reduce the risk of loss to fire. The recommendation management logic module 132 can gather this intent information by asking the risk manager 106 to select a brief instructional phrase from a predetermined list of instructional phrases shown in a drop down menu (such as “Do,” “Do Not Do,” etc.). Comments can be entered to provide further information to assist the plant manager 108 in determining what should be done to address the field consultant 104's recommendations. As will be clarified in Section C below, the user interface presentation that provides the recommendation response report can include two respective input fields that allow the risk manager 106 to enter intent information and comments.

In step 318, the risk manager 106 can send a notification (e.g., an email) to the plant manager 108 that alerts the plant manager 108 to the existence of an outstanding recommendation that requires the plant manager 108's response. In one implementation, the system 100 is configured such that the risk manager 106 is required to manually perform this task, e.g., by pressing a “send” command button to send the notification. (This corresponds to the Fig. 1's depiction of the transmission of email notification 134). In other implementation, the system 100 can be configured to automatically send the notification when the risk manager 106 completes his or her data entry, or performs some other act that indicates that the risk manager 106 has completed data entry.

When the plant manager 108 receives this notification, the plant manager 108 may determine, in step 320, whether there is some aspect of this message that warrants discussion with the risk manager 106. If this is the case, then the procedure 300 can prompt the risk manager 106, in step 322, to contact the principal consultant 110 in attempts to clarify the recommendation information (or to more generally resolve whatever issue that has been identified by the plant manager 108 in step 302).

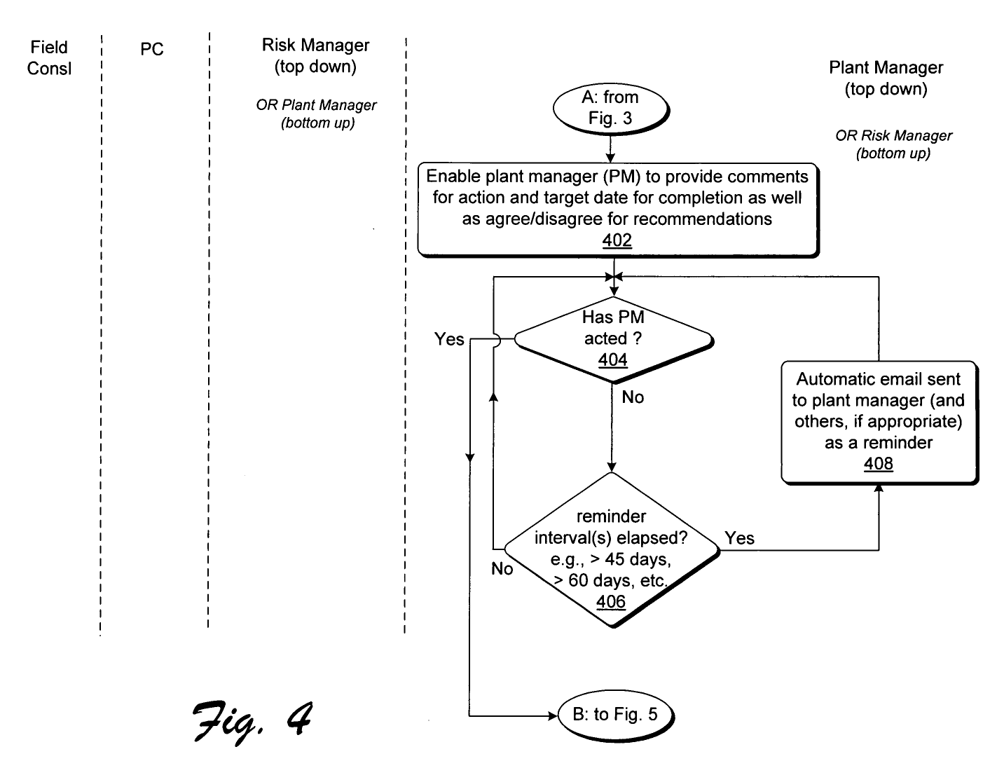

If the plant manager 108 determines that no discussion is required, then the flow advances to step 402 (shown in FIG. 4). Step 402 generally indicates that the recommendation management logic module 132 makes available a recommendation response report that allows the plant manager 108 to enter intent information and comments. In other words, this “step” simply denotes that the recommendation response report exists and is made accessible to the plant manager 108 upon the plant manager 108 entering a valid user name and password. Recall that the risk manager 106, in step 316, has already initiated the recommendation development process by entering his or her intent information and comments into the recommendation response report (based on the recommendations of the field consultant 104). This recommendation response report provides a first section for entering risk management intent information and comments, and a second section for entering plant management intent information and comments (as well as other information to be described below). The task of the plant manager 108 at this stage is to fill out the entry fields in the second section. The plant management intent information and comments effectively constitute the plant manager 108's response to the risk manager 106's instructions.

However, the plant manager 108 may not respond to the risk manager 106 immediately. Reminder notifications (such as reminder emails) are automatically sent to the plant manager 108 in the event that he or she does not respond in a predetermined amount of time. More specifically, the recommendation management logic module 132 can send a first reminder notification after a first period of time (e.g., 45 days) has elapsed with no response, and a second reminder notification after a second period of time (e.g., 60 days) has elapsed, and so forth. The tenor of successive notifications can convey increasing urgency.

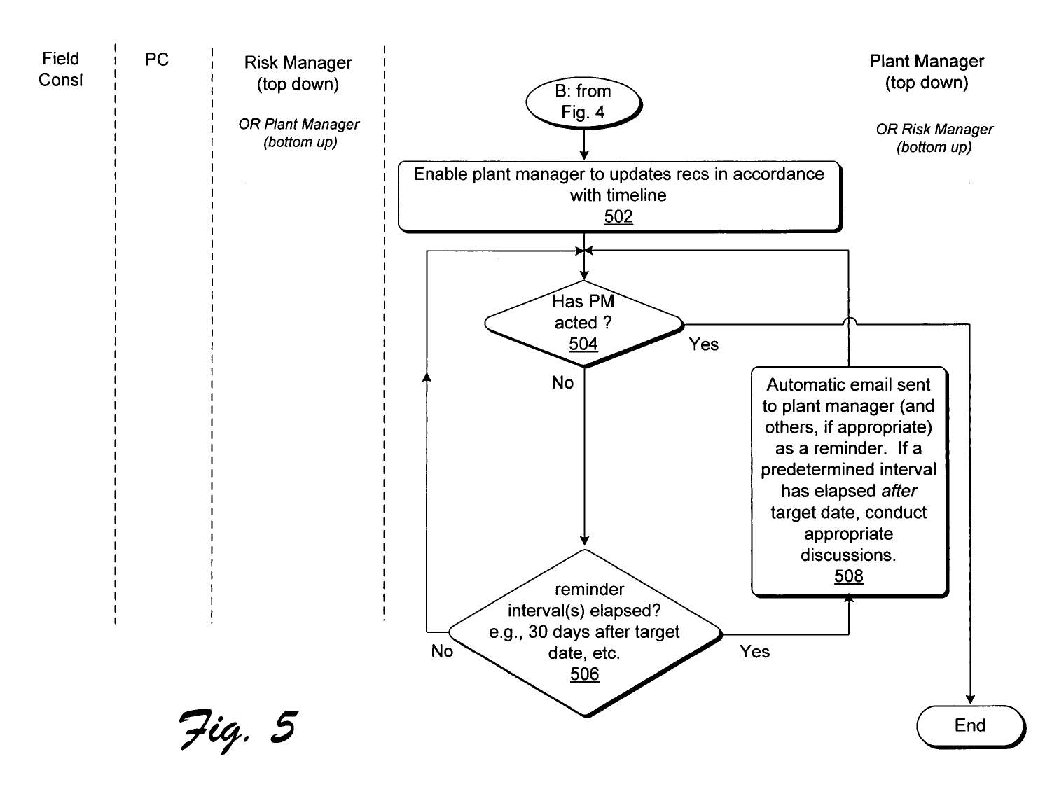

More specifically, FIG. 4 illustrates the above-described notification procedure in steps 404-408. In step 404, the recommendation management logic module 138 determines whether the plant manager 108 has acted or not, that is, whether the plant manager 108 has entered recommendation information into the recommendation response report. If so, then the flow advances to step 502 (of FIG. 5). If there is no response, however, step 406 (of FIG. 4) determines whether a predetermined response period has transpired, such as 45 days, or 60 days, etc. In the event that one of these trigger time intervals has transpired, the recommendation management logic module 132 sends an appropriate reminder notification to the plant manager 108. The notification reminder, depending on its urgency, can also be sent to the risk manager 106, or other appropriate individuals associated with the recommendation. For instance, a first reminder notification can be sent after 45 days to only the plant manager 108. However, a subsequent reminder notification can be sent after 60 days to both the plant manager 108 and the risk manager 106.

A reminder notification sent to just the plant manager 108 after the elapse of a first predetermined time period is shown below:

Exemplary Reminder Notification
From: ReminderFunction@AssetProtectionServices.com
Sent: Wednesday, Dec. 3, 2006 7:59 PM
To: John.Jones@XYZ_Industries.com
Subject: 45 Days Reminder: Property Loss Control Recommendation(s) for location number 55667876, San Francisco, Calif.
The following recommendation(s) were sent to you for review/information 45 days ago. Please review & update these recommendations:
   2001-2-a
   2001-2-b
   2001-3
   2002-4
To view recommendation(s):
   Log onto AssetProtectionServices.com by clicking the link: <https://secure. AssetProtectionServices.com>
   Click on My Recommendations for San Francisco, Calif. (55667876)
   Select “45 Days Reminder” from the ‘Show Me’ filter list.
   If you have forgotten your username and/or password, please click: <mailto: Inquiry@AssetProtectionServices.com>

This exemplary reminder notification generally alerts the plant manager 108 to the fact that the risk manager 106 has entered recommendation information 45 days ago that requires the plant manager 108's response. The body of the reminder notification then provides more detailed information regarding the outstanding recommendation items that require the plant manager 108's response (such as by providing codes that identify respective outstanding recommendation items). Finally, the reminder notification provides specific instructions that allow the plant manager 108 to respond to the recommendation items. That is, these specific instructions can describe a series of steps that the plant manager 108 can take to access the recommendation response report and enter plant management intent information, comments, etc. The meaning of the specific instructions provided in the above exemplary message will be explained in the below discussion regarding the user interface presentations (in Section C). While this message pertains to only the first reminder notification (corresponding to the 45 day mark), other reminder notifications can be structured in a similar manner. The other reminder notifications will identify their respective triggering events; for example, a reminder sent out at the 60 day mark will identify the outstanding action item as 60 days “late.” Assume that the plant manager 108, or other appropriate individual, eventually responds. As mentioned, a response may include the specification of plant management intent information, optional comments, and a target date. The target date specifies the date by which the plant manager 108 believes that the recommendations will be implemented in the plant 102. A plant manager 108 (or other appropriate individual) can also input status information which reflects the status of the implementation efforts (e.g., “In Progress,” “Complete,” etc.). The plant manager 108 (or other appropriate individual) is expected to timely update the status information when the status of the implementation effort changes (e.g., when the implementation is completed). The procedure 300 terminates when the plant manager 108 (or other appropriate individual) indicates that the recommendation has been successfully resolved.

Advancing to FIG. 5, step 502 generally indicates that recommendation response report is made available to the plant manager 108 throughout the implementation effort so that the plant manager 108 (or other appropriate individual) can timely update the status information.

As indicated in FIG. 5, the entry of a target date also enables a series of additional reminder notifications that can be sent out at times that are relative to the target date. For example, providing that the plant manager 108 (or other appropriate individual) has not updated the recommendation response report to indicate that the implementation has been completed, a reminder notification can be sent out a predetermined time prior to the target date, and/or on the target date itself, and/or a predetermined time after the target date. More specifically, step 504 determines whether the plant manager 108 (or other appropriate individual) has updated the status field of the recommendation response report (e.g., to indicate that the implementation has been completed or that the implementation has some other terminal status). If not, step 506 determines whether it is time to send a reminder notification based upon whether one or more triggering conditions has been meet. As noted above, a reminder notification can be sent a predetermined time prior to the target date (e.g., 30 days prior to the target date). Another reminder notification can be sent on the target date itself. Yet another reminder notification can be sent a predetermined time after the target date (e.g., 30 days after the target date). These triggering conditions are exemplary; the criteria used to govern the transmission of reminder notifications can be tailored to suit the requirements of different business environments. In step 508, the response recommendation logic module 132 sends out an appropriate reminder notification if one of the above-described triggering conditions has been meet. A first reminder notification can be sent to the plant manager 108. Subsequent reminder notifications can be sent to the plant manager 108 along with other appropriate individuals, such as the risk manager 106. Although not shown in FIG. 5, subsequent reminder notifications can also prompt discussion between appropriate actors to attempt to resolve any outstanding issues regarding the recommendations. As mentioned above, the procedure 300 terminates (along with its attendant reminders) when an appropriate individual indicates that the recommendations have been resolved. For example, the recommendation management logic module 132 can stop sending reminders when the field consultant 104 surveys the facility again and verifies that the recommendation has been completed.

Although not shown in FIGS. 3-5, other reminder notifications can be sent out in batch fashion, e.g., at the end of every business quarter. Different rules can be applied to govern what recommendation items are included in these reports and who should receive these reminder notifications.

C. User Interface Presentations

FIGS. 6-22 provide exemplary user interface presentations that are furnished by the recommendation management logic module 132 of the processing functionality 124. The user interface presentations can be implemented as graphical web pages having various user input fields, various hypertext linked fields, various command buttons, various pull down menus, and so forth. The user can interact with the graphical user interface presentations in a conventional manner, e.g., using a mouse device, keyboard, and/or other type of interface device.

To continue the concrete example introduced in prior sections, the following discussion will describe the user interface presentations in the exemplary context of a top-down process flow. That is, the series of user interface presentations are arranged in an order that generally corresponds to the exemplary top-down process flow. However, the series of user interface presentations can be modified to function in a bottom-up flow without departing from the principles described herein. Generally, the selection and arrangement of information and input fields on the illustrated user interface presentations are exemplary.

To begin with, a particular implementation can provide a variety of navigation routes and interface strategies which allow a user to select the recommendation response report (to be described shortly). FIGS. 6-9 show an exemplary sequence of interface presentations that can be used to navigate to the recommendation response report. In connection with these figures, assume that the risk manager 106 first logs into the system 100. The risk manager 106 performs this task by first inputting his or her user name and password into an appropriately configured login user interface presentation (not shown). The role-based security logic module 130 responds to this login request by determining the access privileges (encompassing viewing privileges), edit privileges, send privileges, and modification privileges associated with the user (which in this case is the risk manager 106), and then by presenting an introductory display appropriate to the user's access privileges.

Assume that the introductory display for the risk manager 106 corresponds to the user interface presentation 600 shown in FIG. 6. This presentation 600 includes a main presentation section 602, a conventional browser command bar 604 (e.g., for performing such tasks as advancing between web pages, saving information, refreshing a web page, and so forth), a plurality of vertically disposed menu options 606, a plurality of horizontal tab-type menu options 608, etc. All of the menu options are not directly relevant to the recommendation management functionality being described herein, and accordingly will not be explained in detail. In general, the tab option “My Analysis” 610 in the horizontal menu 608 provides access to a series of tools and/or reports that provide analysis of data collected from the business. Finally, a conventional slider bar 612 allows the user to view different parts of the user interface presentation 600, providing that the entire page cannot be seen at once.

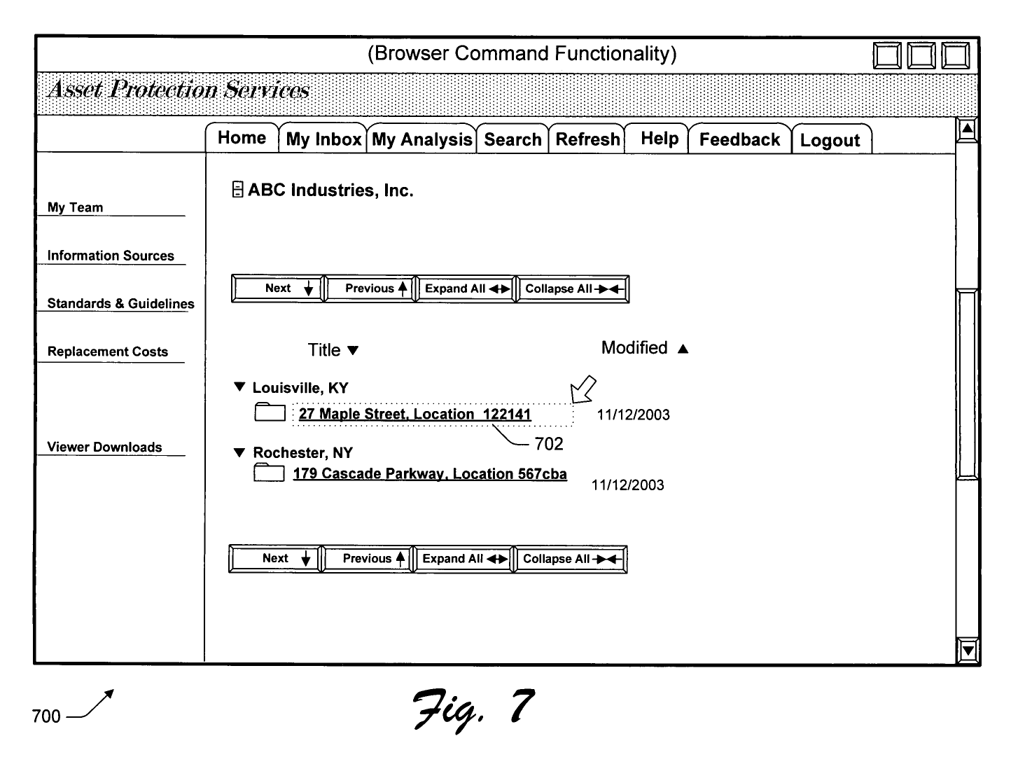

In one illustrative example, the main presentation section 602 presents information regarding a particular business named “ABC Industries, Inc.” The two horizontal rows of command buttons 614 allow the user to advance to a next business (if available), move to a previous business (if available), expand the list of businesses, and contract the list of businesses, respectively. A file cabinet symbol adjacent to the name “ABC Industries, Inc.” indicates that a plurality of resources (e.g., documents and other information) are available that pertain to this business. The name of the business has a hypertext link associated with it. Clicking on this link, as indicated by activated field 616, prompts the recommendation management logic module 132 to present the user interface presentation 700 shown in FIG. 7.

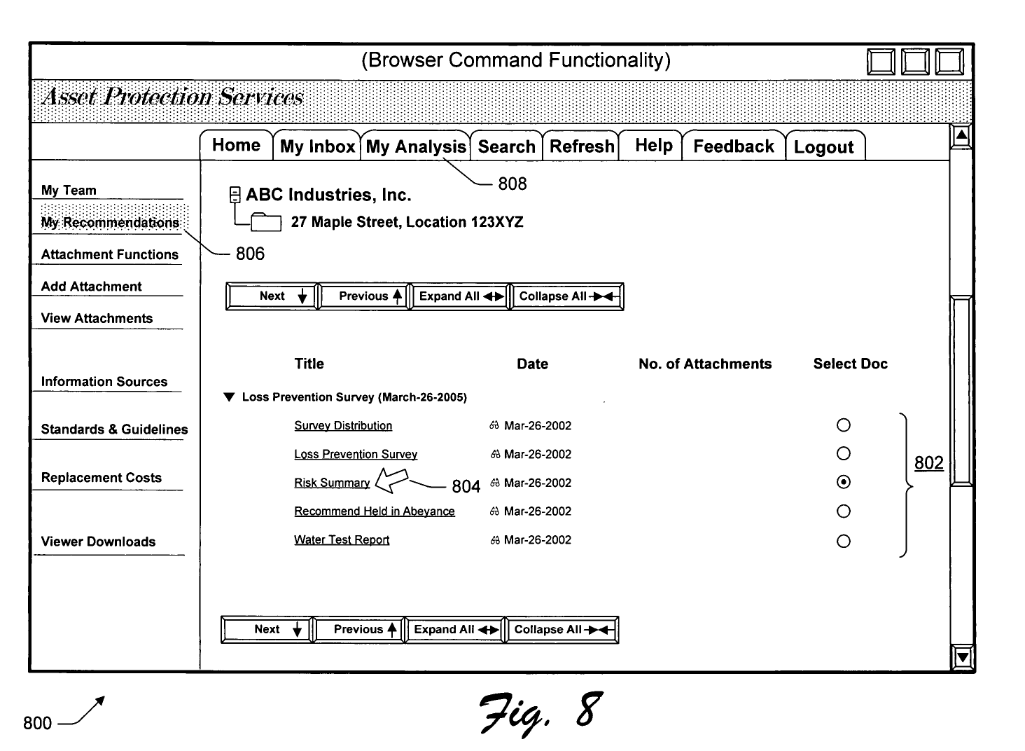

The user interface presentation 700 shown in FIG. 7 shows the plants associated with the business ABC Industries, Inc. In the present exemplary case, the business includes two divisions or plants, one located in Louisville, Ky., and the other located in Rochester, N.Y. Each of these divisions or plants has a hypertext link associated therewith. Presume, in this example, that risk manager 106 wishes to review the resources (e.g., documents) associated with the first-listed business division, i.e., Louisville, Ky. This can be performed by clicking on the hypertext link associated with the Louisville, Ky. location, as indicated by the activated field 702 shown in FIG. 7. This action will prompt the recommendation management logic module 132 to display the user interface presentation 800 shown in FIG. 8.

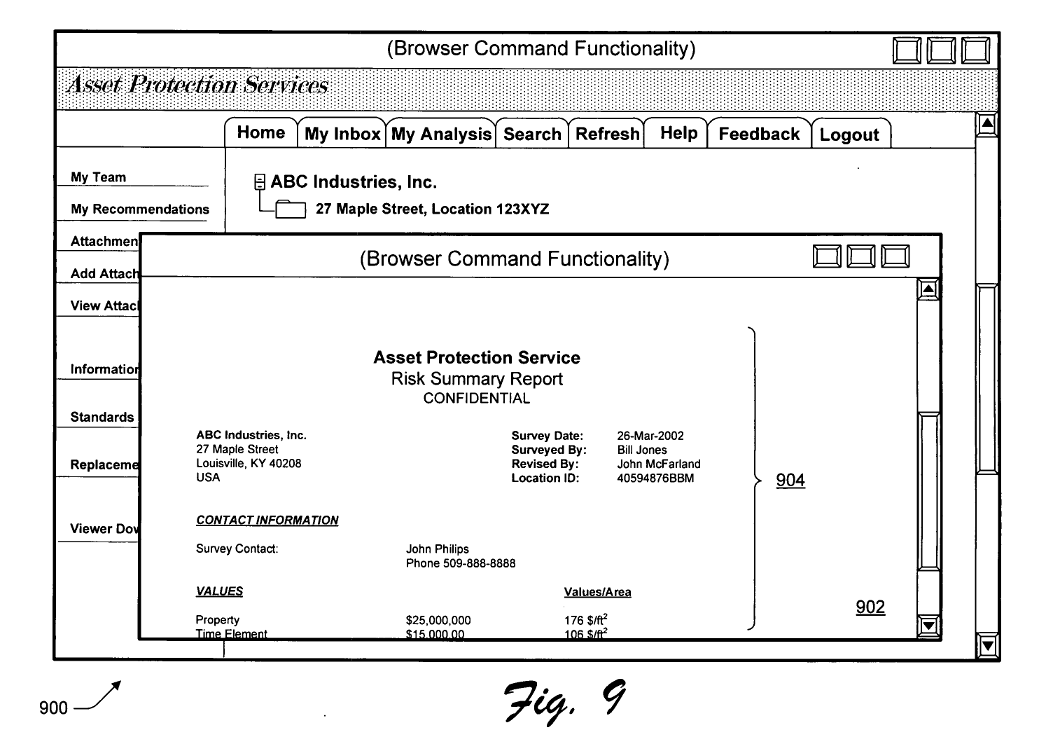

The user interface presentation 800 shown in FIG. 8 specifies a plurality of resources 802 associated with the selected plant location, e.g., Louisville, Ky. These resources 802 include a survey distribution report, a loss prevention survey report, a risk summary, a recommendation held in abeyance report, and a water test report. All of these document names have hypertext links associated therewith. Clicking on one of these links will activate the appropriate report for inspection (that is, if the user has sufficient access rights to view the report). For example, clicking on the risk summary report prompts the generation of user interface presentation 900 shown in FIG. 9.

The user interface presentation 900 shown in FIG. 9 includes a separate window display 902 that presents the selected document (in this case a risk summary report 904) for inspection by the risk manager 106. The report 904 includes header information that identifies the business and plant location associated with the report. The report 904 also includes various analysis results or other data. Various technologies can be used to present the report 904, such as Adobe Acrobat of San Jose, Calif. The risk manager 106 may choose to examine one or more reports prior to advancing to the recommendation response report (described below) to gain a better understanding of the field consultant 104's analysis, or to gain other insight into the operation of the business.

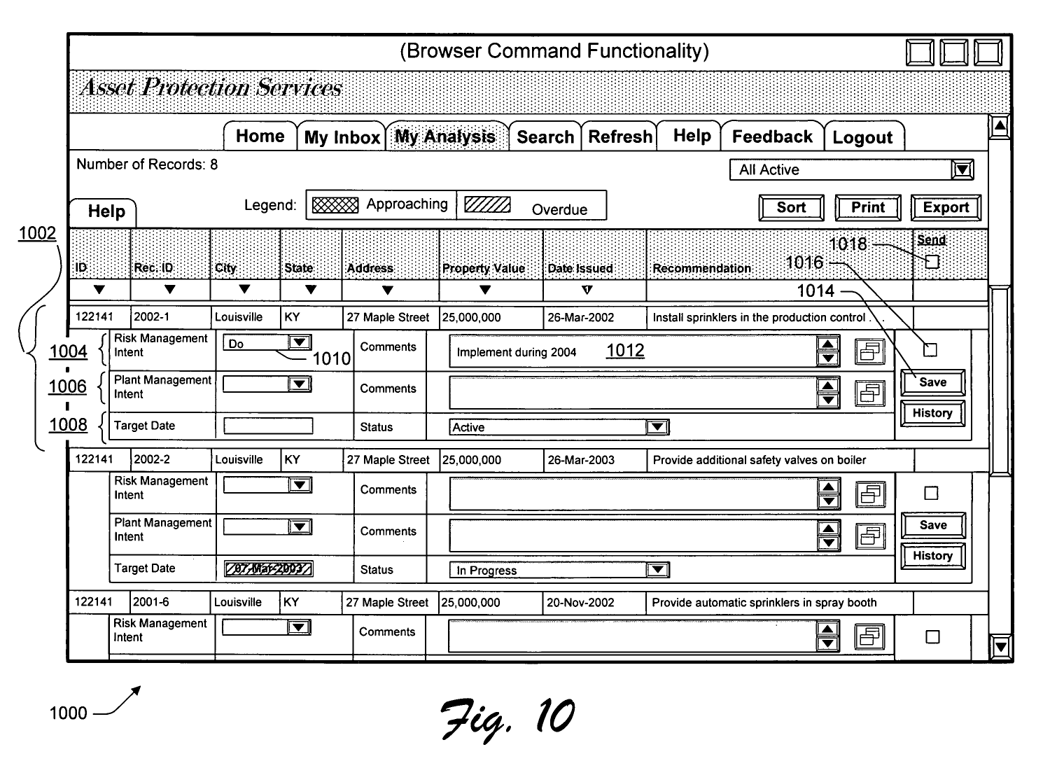

Returning momentarily to FIG. 8, one way to finally advance to the recommendation response report is to select the “My Recommendations” field 806 shown in the left hand vertical list of menu choices. This prompts the generation of the user interface presentation 1000 shown in FIG. 10 that provides the recommendation response report. (That is, the recommendation response report collectively represents all of the information shown in the user interface presentation 1000 of FIG. 10.) However, this series of navigation options is exemplary. There are other navigational routes that can be used to access the recommendation report, such as by accessing this report as by directly activating the My Analysis tab 808.

Advancing now to FIG. 10, the recommendation response report includes plural sections corresponding to individual recommendations made by the field consultant 104 (or by another authorized actor having access to the system 100). For instance, one such recommendation section is labeled as section 1002. Each section includes a heading that identifies the recommendation by providing several fields of information, including location ID, recommendation ID (Rec ID), city where the plant is located, state where the plant is located, street address where the plant is located, the value of the property, the issue date on which the recommendation was created, and the recommendations made by the field consultant 104. For instance, in the case of recommendation section 1002, the field consultant 104 entered a recommendation to install sprinklers in a control room of the plant, and this information thus appears in the appropriate column of this section 1002. The above-identified information in the recommendation response report can be directly extracted from the information keyed in by the field consultant 104 (e.g., as provided in the field consultant 104's survey report). This provision is beneficial as it reduces the amount of burdensome re-keying of information that must be performed in other approaches and it reduces potential errors that may be caused by such re-keying of data. Section 1002 may abbreviate certain entries from the field consultant 104's survey report. The user can access and view the full entries by clicking on appropriate fields in section 1002.

Following the heading, section 1002 includes three horizontal rows of data entry fields, such as, for example, row 1004, row 1006 and row 1008. These rows generically receive recommendation information as this term is broadly used herein. More specifically, the first row 1004 is dedicated to receiving the risk manager 106's intent information (e.g., “risk management intent”) and comments. The second row is dedicated to receiving the plant manager 108's intent information (e.g., “plant management intent”) and comments. And the third row is dedicated to receiving a target date and associated status information (e.g., from the plant manager 108). The target date refers to a projected date when the recommendation is scheduled to be implemented. The status information reflects the status of the efforts to implement the recommendation in the plant. (The row of black triangles is associated with sorting functionality described in the above-cited related co-pending applications.)

By way of overview, in the top-down approach to developing a recommendation, the risk manager 106 enters the risk management intent information and comments first. This information is entered in data entry fields 1010 and 1012, respectively. The risk manager 106 can then save this recommendation information by activating the save command button 1014. After saving this recommendation information, the risk manager 106 can alert the plant manager 108 of the presence of this action item so that the plant manager 108 can respond by adding his or her recommendation information for this item. This operation can be performed by activating the checkbox 1016 associated with the recommendation and then activating the send hypertext link 1018. As will be discussed, the plant manager 108 can then respond by calling up the recommendation response report and entering the plant management intent information and comments in the second row 1006. The plant manager 108 can also enter the target date and status information in the third row 1008.

Section 1002 is one section among a potential plurality of such sections corresponding to different recommendations originated by the field consultant 104. Each of the other sections includes the same kind of functionality as section 102 discussed above.

The following discussion will drill down on the process summarized above by describing individual steps in the process. Again, the sequence of user interface presentations corresponds to the exemplary top-down flow model.

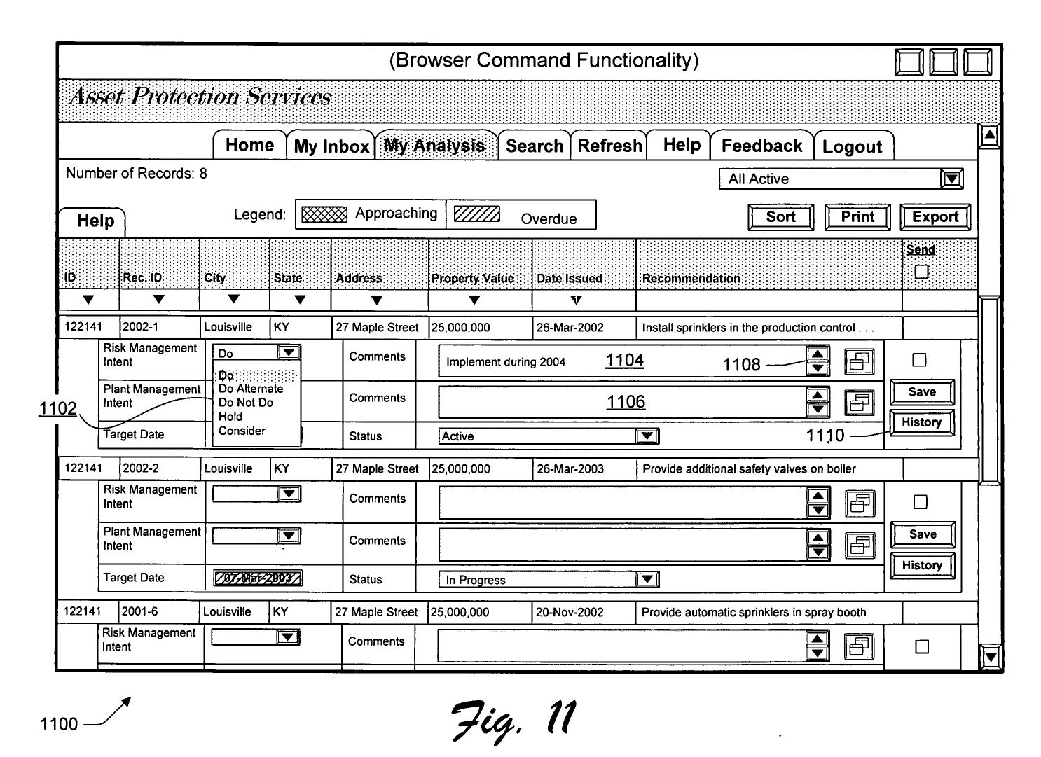

Turning now to FIG. 11, the data entry fields that receive the risk management intent information, plant management intent information, and status information can be configured to receive one of a set of predetermined (i.e., “pre-canned”) phrases. For instance, the risk management intent information can be supplied by selecting from the following group of phrases that capture different possible instructions from the risk manager 106: “Do”; “Do Alternate”; “Do Not Do”; “Hold”; and “Consider.” The above-described exemplary and non-limiting phrases are selected by the risk manager 106 to instruct the plant manager 108 to implement the recommendation (i.e., “Do”), take an alternative course of action (i.e., “Do Alternate”), to not implement the recommendation (i.e., “Do Not Do”), to hold off on implementing the recommendation (i.e., “Hold”), and to consider the desirability of implementing the recommendation (i.e., “Consider”). These command phrases may reflect the practice and terminology used in a particular exemplary business culture, and can be modified to suit different business environments.

FIG. 11 shows the use of a drop-down menu 1102 for allowing the risk manager 106 to input one of the above-identified phases. This input mechanism is exemplary. For instance, the recommendation response report can receive the risk manager 106's input via a free-form text entry box or via some other input mechanism. In the case of a free-form text entry box, the recommendation response report can be configured to allow the risk manager 106 to enter any pre-defined phrase that captures his or her intent.

The plant manager 108 can likewise draw from a predetermined set of phrases in supplying the plant management intent information. For instance, when responding to the risk manager 106, the plant manager 108 can select from the following group of options: an “Agree” entry that indicates that the plant manager 108 agrees with the risk manager 106; and a “Disagree” entry that indicates that the plant manager 108 disagrees with the risk manager 106. As will be illustrated in a later figure, these phrases can be entered via a drop down box similar to that shown for the case of the risk management intent information. Alternatively, the plant management intent information can be entered via a free-form text entry input box or some other input mechanism. The phrases “Agree” and “Disagree” are exemplary; other phases can be used that are better tailored to other business cultures.

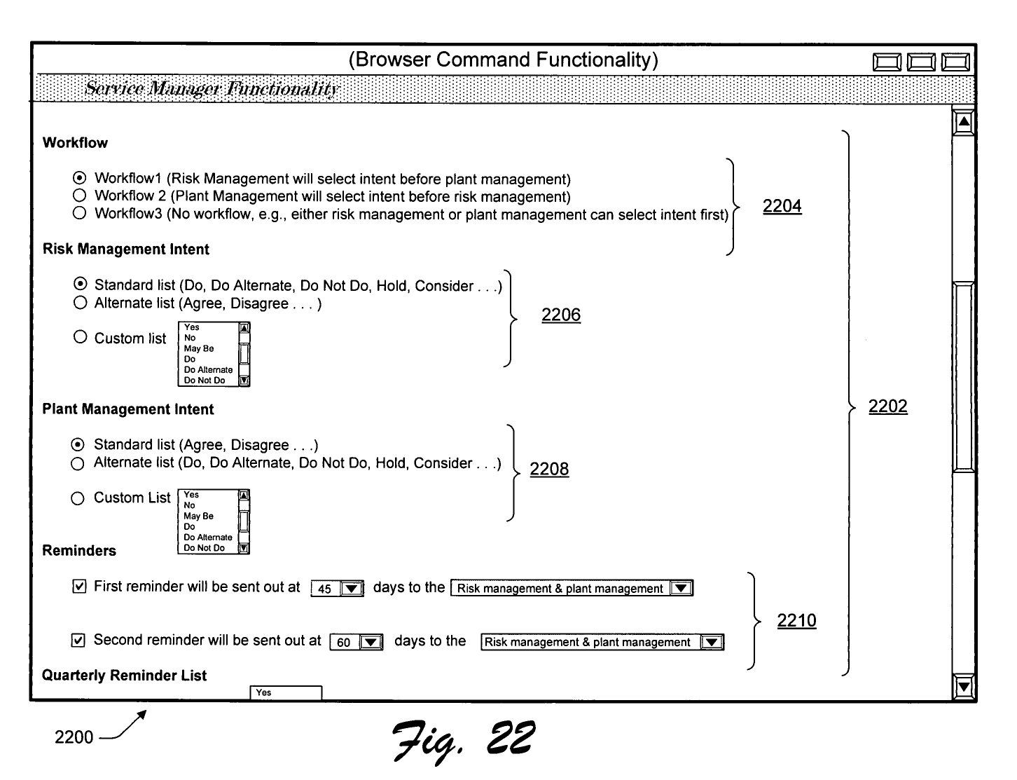

Finally, the status information can also draw from a predetermined set of phrases that capture the status of the implementation of the recommendation. For instance, this set can include: an “Active” entry that indicates that there is a current intent to implement the recommendation; a “Complete” entry that indicates that the implementation is complete; an “Under Evaluation” entry that indicates that the recommendation is currently undergoing evaluation; a “Delayed/On hold” entry that indicates that the implementation has been delayed or is currently on hold; a “No Longer Applicable” entry that indicates the recommendation and its implementation are no longer applicable for any reason; an “In Progress” field that indicates that the implementation is currently in progress; and a “Will not complete” entry which indicates that the plant 102 has no intention of completing the recommendation for any reason. These phrases can be entered via a drop down box similar to that shown for the case of the risk management intent information. Alternatively, the status information can be entered via a free-form text entry input box or some other input mechanism. The particular status phrases mentioned above are exemplary; other business environments can adopt different phrases to suit their respective cultures. More specifically, as will be described below (with reference to FIG. 22), a customization user interface presentation gives administrators flexibility in tailoring the recommendation response report to suit the phraseology and practices used in a particular business environment. The risk management intent phrases, plant management intent phrases, and status phrases can be changed via this user interface presentation.

The risk manager 106 and the plant manager 108 can enter their comments in text entry fields 1104 and 1106 respectively. These text entry fields (1104, 1106) can allow for free-form text entry. The risk manager 106 and plant manager 108 can generally supply any information to these fields (1104, 1106) that may be necessary to communicate with each other. The full extent of their comments may span several lines. The text entry fields (1104, 1106) may show only a truncated portion of these multi-line comments. The up and down commands buttons (such as the up and down command buttons 1108 for the risk manager 106's comments) prompt the respective text entry fields (1104, 1106) to scroll through the complete messages. Further, “enlarge” functionality can be activated (e.g., by pressing an appropriate command button) to prompt the presentation of a separate window-type panel (not shown) which shows a comment in its entirety.

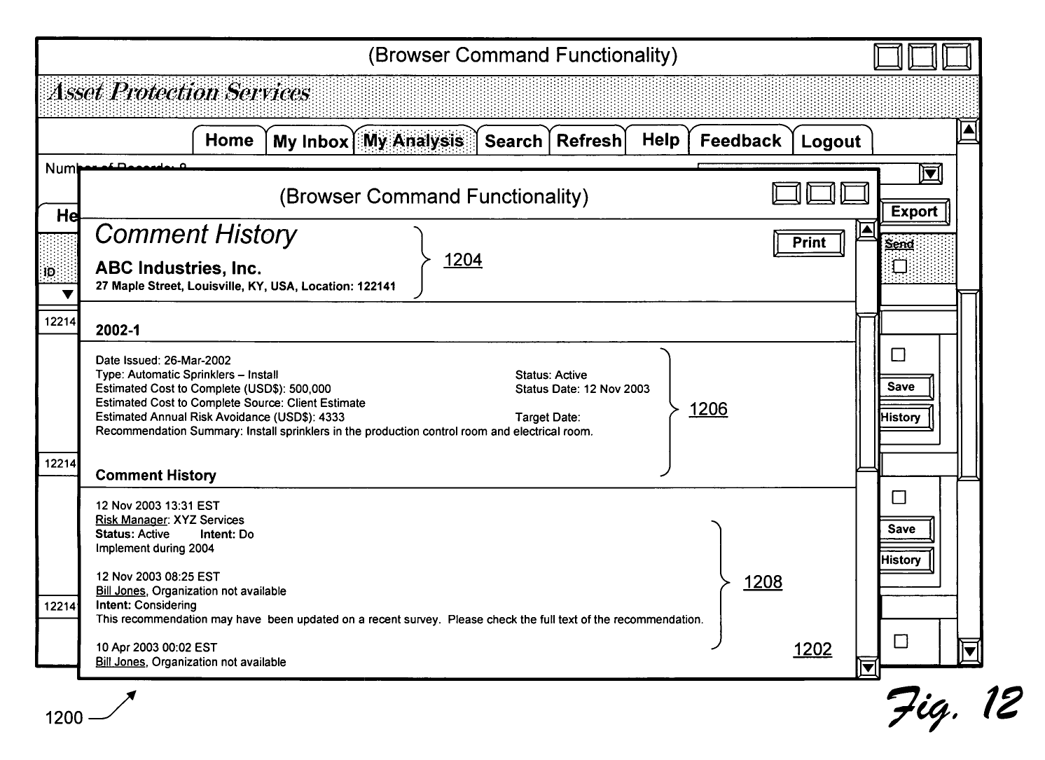

In addition, the user can examine additional details regarding the recommendations by activating a history command button 1110. This prompts the recommendation management logic module 132 to display the user interface presentation 1200 shown in FIG. 12. This user interface presentation 1200 includes a history presentation 1202 that provides a detailed listing of the comments made pertaining to an individual recommendation. More specifically, the history presentation 1202 includes a first section 1204 that identifies the business and the plant associated with the recommendation. Another section 1206 provides other metadata regarding the recommendation, such as, in one exemplary implementation: date issued (that is, the date that the field consultant 104 made the original recommendation); type; estimated cost to complete; estimated cost to complete source; estimated annual risk avoidance; and recommendation summary. Section 1208 identifies a historical sequence of intent information, status update information, target date information, user information, and comments that have been entered pertaining to the original recommendation. In one implementation, this section 1208 can organize these entries from the most recent comment (on top) to the least recent comment (on the bottom). For instance, if the risk manager 106 makes an entry followed by the plant manager 108, then the plant manager 108's entry would appear on top of the risk manager 106's entry. In the present case, however, the comment history only shows that a plant was evaluated by the field consultant 104, and then the risk manager 106 entered risk management intent information and comments. In other words, at this particular exemplary juncture in the process flow, the plant manager 108 has not yet entered his or her intent information or comments, so the history does not contain an entry attributed to the plant manager 108.

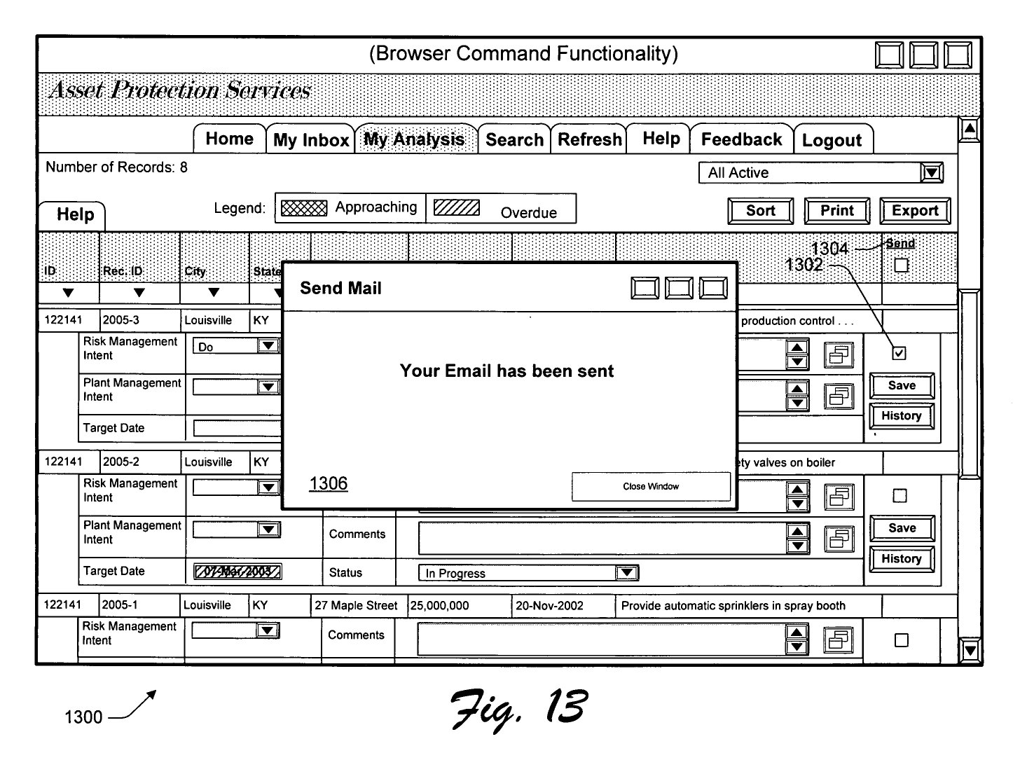

To establish a frame of reference with the previously discussed procedure 300, FIGS. 11-12 show the user interface presentations through which the risk manager 106 can perform step 316 in FIG. 3 (e.g., which pertains to entering of intent information and comments). Then, in step 318, the risk manager 106 can manually send a notification to the plant manager 108 that alerts the plant manager 108 to the presence of a new action item requiring his or her attention. With reference to the user interface presentation 1300 of FIG. 13, and as previously described, this notification can be performed by requiring the risk manager 106 to activate the check box 1302 associated with the recommendation and then activate the send command 1304. A window-type display 1306 can then be displayed to the risk manager 106 that alerts the risk manager 106 to the fact that the notification has been sent to the plant manager 108. Alternatively, the recommendation management logic module 132 can be configured to automatically send the notification to the plant manager 108 after the risk manager 106 has made his or her data entry.

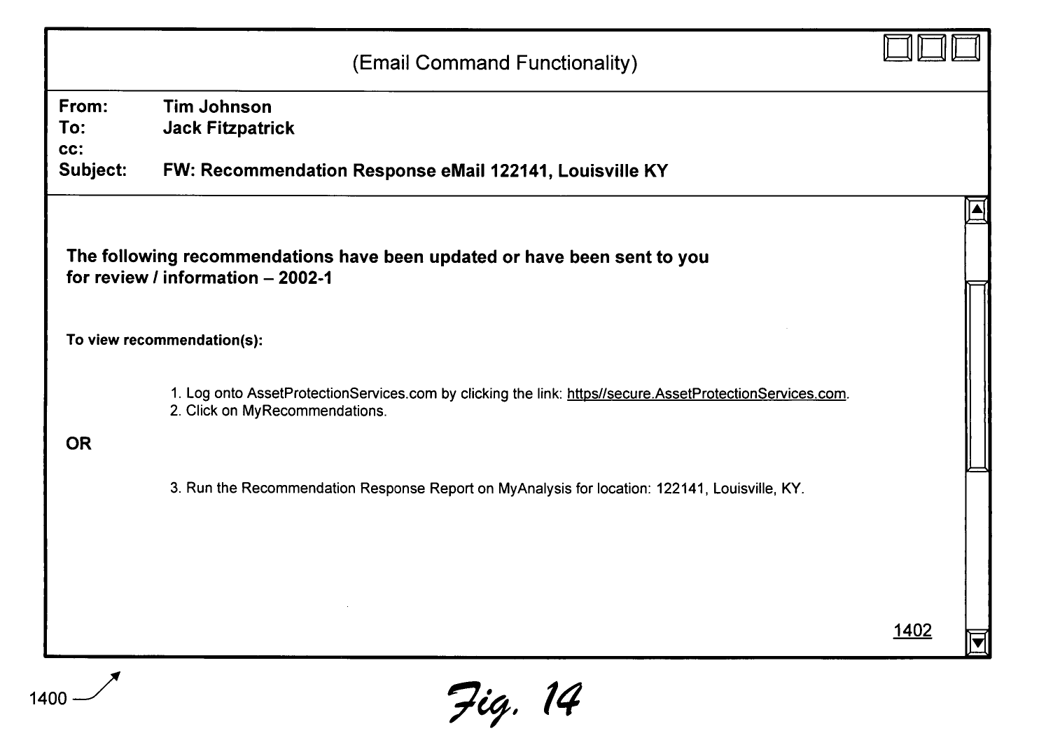

FIG. 14 shows the composition of an exemplary user interface presentation 1400 that shows an exemplary composition of the notification that can be sent to the plant manager 108 in response to the actions described above. This notification can include a conventional header portion that identifies the source of the notification, the recipient of the notification, and the subject matter of the notification. The body of the notification can provide introductory information that identifies the action item that warrants the plant manager 108's attention. The body of the notification can also provide detailed instructions regarding how the plant manager 108 can activate the response recommendation report so that the plant manager 108 can formally respond to the risk manager 106.

Upon receiving the notification described in FIG. 14, the plant manager 108 can respond by activating the response recommendation report. One way to navigate to this report is to sequence through the user interface presentations described above (e.g., in FIGS. 6, 7 and 8) in the context of the risk manager 106's interaction with the system 100. Namely, the plant manager 108 can log into the system 100 by providing his or her user name and password. The role-based security logic module 130 of the processing functionality 124 responds by granting the plant manager 108 access to the functionality provided by the recommendation management logic module 132 (that is, providing that the plant manager 108 is an authorized user).

In addition, the role-based security logic 130 can be configured to provide the plant manager 108 with user interface presentations that are specifically tailored to his or her role within the business. Accordingly, the plant manager 108 may not be able to see and interact with all of the information that the risk manager 106 can see and interact with. For instance, upon logging into the system 100, the plant manager 108 may be presented with a file cabinet entry corresponding to the business (“ABC Industries, Inc.”), as was the case in FIG. 6 for the risk manager 106. However, upon activating the file cabinet entry for this business, the recommendation management logic module 132 can be configured to present only a folder corresponding to the plant 102 that the plant manager 108 is affiliated with, rather than multiple folders for the business as a whole. As previously described, the plant manager 108 can click on the hypertext link corresponding to his or her local plant 102 to view a list of resources (e.g., reports) associated with that plant 102. The plant manager 108 can activate any of these resources to view the resource in the manner previously described with respect to the risk manager 106.

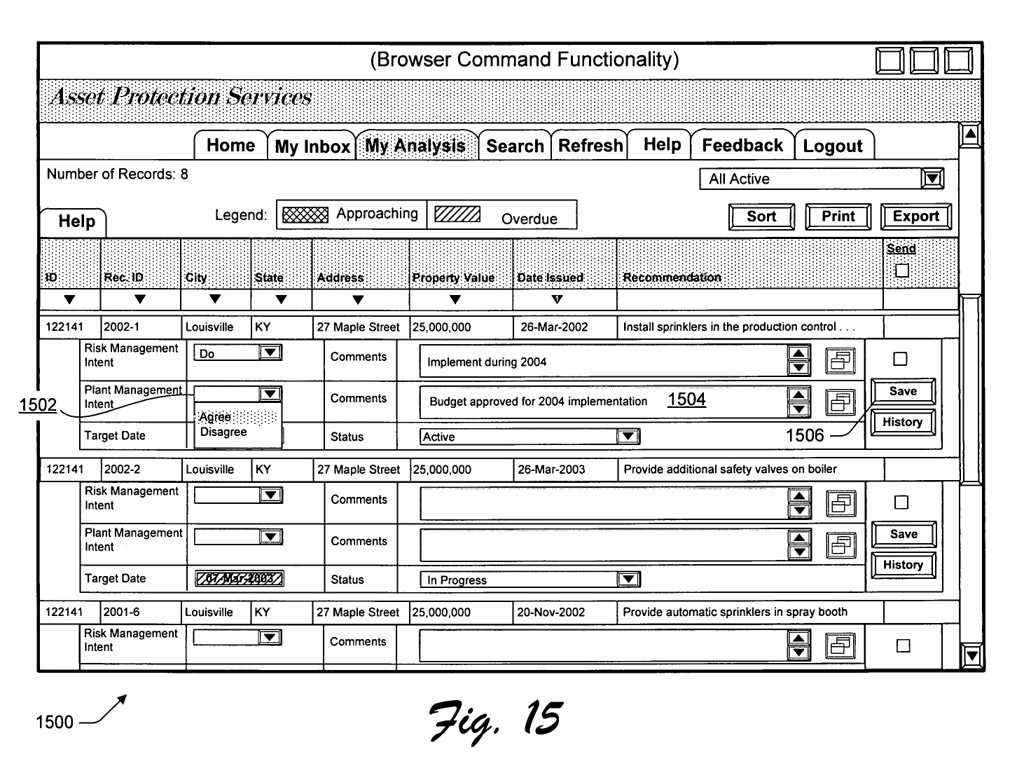

To navigate to the response recommendation report, the plant manager 108 can activate the “My Recommendations” menu option in the vertical list of options to the left of the user interface presentation (as previously described in the context of FIG. 8). This calls up the recommendation response report user interface presentation 1500 as shown in FIG. 15. This recommendation response report includes all of the fields previously described in the context of FIG. 10. Generally, at this point in the process flow, it is the responsibility of the plant manager 108 to respond to the recommendation information provided by the risk manager 106 (e.g., the risk management intent information and associated commentary). This entails entering plant manager intent information. The plant manager 108 can enter intent information by selecting a phrase from a predetermined group of possible phrases appearing in the drop down menu 1502 (e.g., “Agree” or “Disagree” to indicate whether the plant manager 108 agrees or disagrees with the risk manager 106's instructions). The plant manager 108 can also enter optional comments in the text entry field 1504. The plant manager 108 can activate the save command button 1506 to save these entries.

The plant manager 108 (or other authorized individual, such as a broker, corporate user, principal consultant or field consultant) can also be tasked with the responsibility of entering a target date. This target date reflects when the recommendation is scheduled to be implemented. The plant manager 108 (or other authorized individual) can enter the target date at the same time he or she enters the plant management intent information and comments, or at a later time.

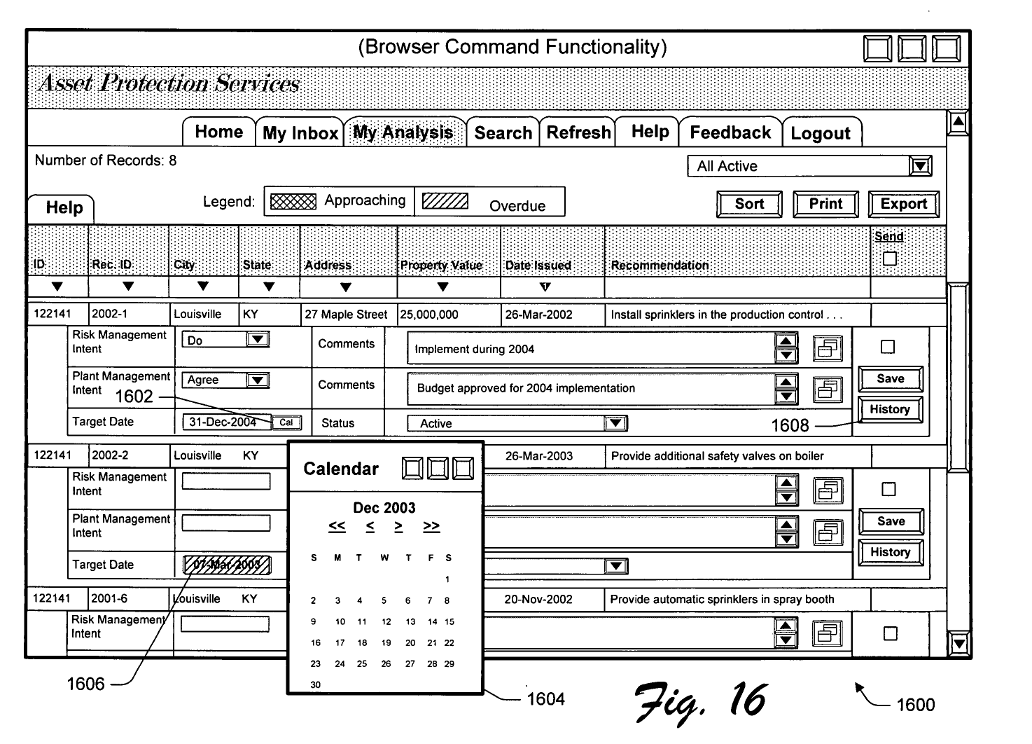

FIG. 16 shows a user interface presentation 1600 that illustrates functionality for specifying the target date. In one implementation, when the plant manager 108 (or other authorized individual) activates the target date entry field 1602, the recommendation management logic module 132 responds by showing a calendar display 1604. The plant manager 108 (or other authorized individual) responds by selecting the target date within the calendar display 1604 (e.g., by interacting with the calendar display 1604 using a mouse device or other kind of selection and input device). Alternatively, the plant manager 108 (or other authorized individual) can enter the target date using free-form text entry or through some other input mechanism.

The plant manager 108 (or other authorized individual) can input status information in the manner described previously, e.g., by selecting a phrase from a predetermined set of possible phrases, or by directly entering free-form text. The plant manager 108 (or other authorized individual) is expected to revisit the status at one or more junctures in the process to ensure that it is up to date. Thus, for instance, when the implementation is completed, the plant manager 108 (or other authorized individual) should activate the recommendation response report and change the status field to indicate that the implementation is “Complete.”

Finally, with respect to FIG. 16, the recommendation management logic module 132 can color code the target date field to indicate different levels of urgency associated with this date. For instance, if the present date is within a predetermined time interval of the target date (such that the target date is near at hand), then the recommendation management logic module 132 can be configured to display the target date in a first color, such as yellow. When the present date is past the target date (or the present date is the target date itself), then the recommendation management logic module can be configured to display the target date in a second color, such as red. The level of urgency can be conveyed in other ways, such as by adding symbolic information which indicates the urgency associated with the target date, adding animation to the target date (such as “blinking” the target date or providing a running light border around the target date), and so on. This provision allows the users to be quickly and conveniently apprised of critical recommendations that have not been addressed. In addition, or alternatively, the criticality associated with the target date can be conveyed with any kind of audible information.

Any other field of the user interface presentations can also include a visual attribute, such as color, which conveys the time-varying importance of such a field, or which conveys some other characteristic of the field. For instance, various fields associated with the risk management and/or plant management intent information can include a visual attribute which conveys information regarding their status. For example, in the top-down mode of operation, various input fields associated with the plant management intent information can be displayed in various colors to convey the plant manager 108's degree of tardiness in responding to the risk manager 106 or in responding to another action item. In addition, or alternatively, the criticality associated with any field can be conveyed with any kind of audible information.

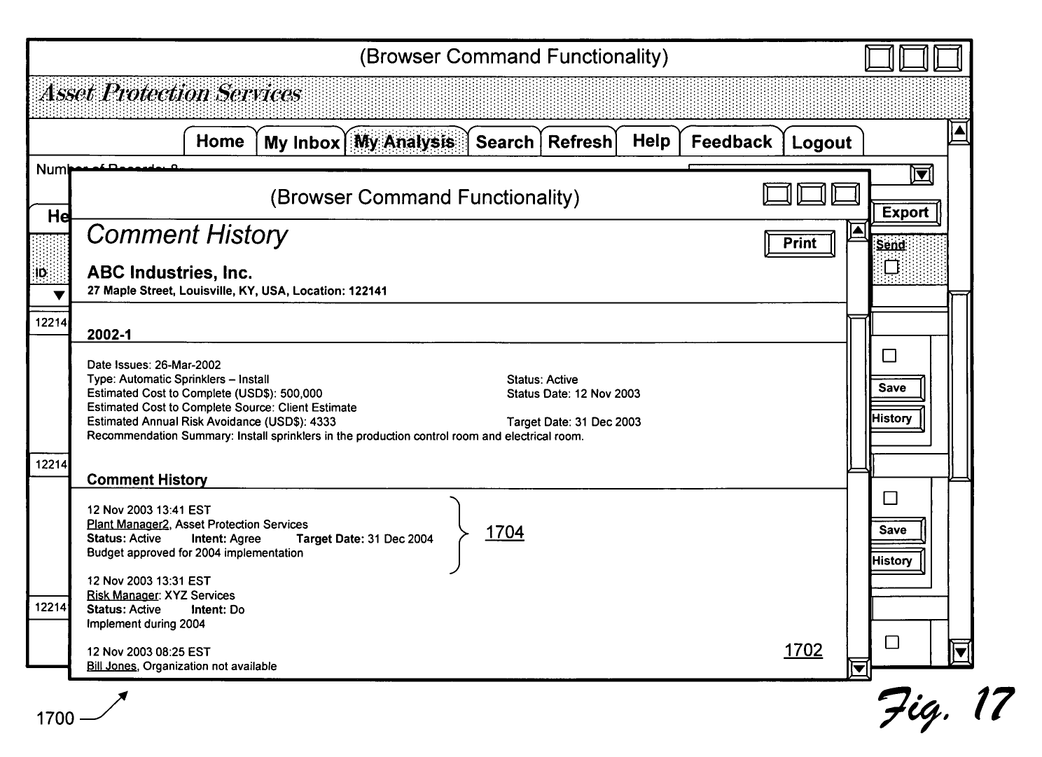

Continuing on, following the entering of all of the above-described information, the comment history presentation will have another entry corresponding to the information entered by the plant manager 108. For instance, upon activating the history command button 1608 shown in FIG. 16, the user interface presentation 1700 shown in FIG. 17 is displayed. This user interface presentation includes a report 1702 similar that described in the context of FIG. 12. The comment history will now include an entry 1704 that describes the information input by the plant manager 108 (or other authorized individual).

For frame of reference, the above-described activities performed by the plant manager 108 correspond to steps 402, 404, 502 and 504 of FIGS. 4 and 5.

To repeat, the above-described sequence of interaction with the user interface presentations reflects a top-down flow methodology. A different sequence of interaction can be provided in the case that a bottom-up flow methodology is being used to develop recommendations.

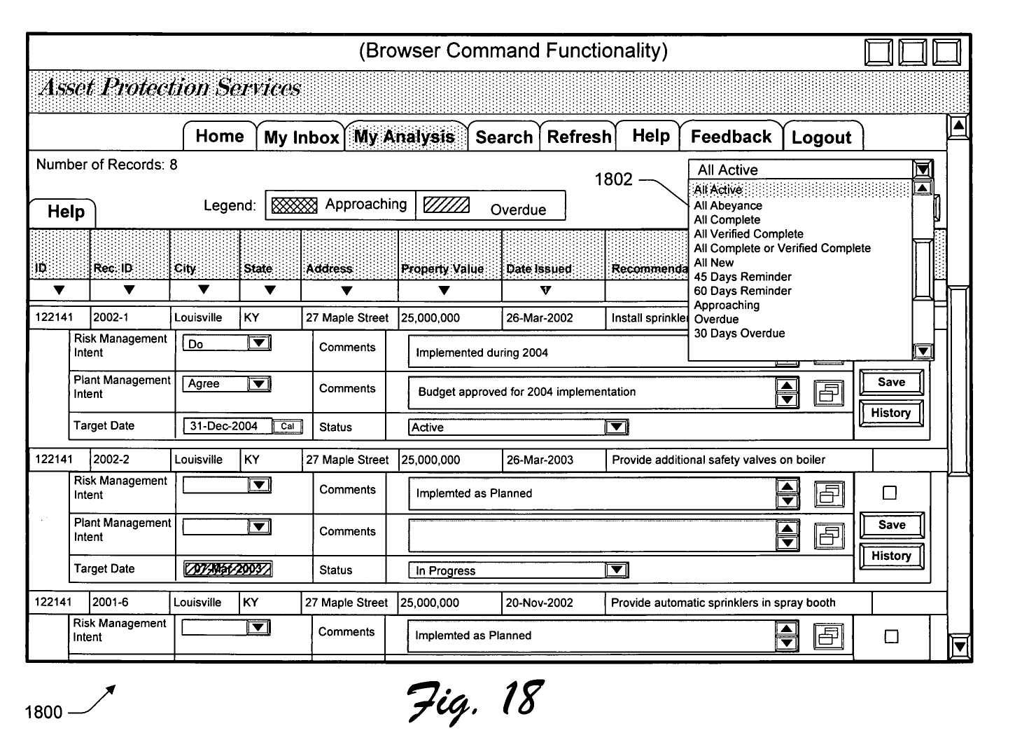

The remaining figures show other user interface presentations that can be provided by the processing functionality 124. These features may be accessible to any user (e.g., to both the risk manager 106 and the plant manager 108, or to other users), or can be restricted to only certain users who serve appropriate roles in the business. For instance, FIG. 18 shows a user interface presentation 1800 that illustrates the ability of the recommendation management logic module 132 to filter recommendation-related entries according to a variety of criteria. This enables the recommendation management logic module 132 to selectively display a recommendation response report that includes only those entries meeting the predefined criteria. This filtered recommendation response report can be printed out, exported in a defined file format, and so forth.

More specifically, the user interface presentation 1800 shown in FIG. 18 allows the user to select filter criteria via drop down menu 1802. This drop down menu describes different status categories associated with recommendations. The filter criteria include: “All Active”; “All Abeyance”; “All Complete”; “All Verified Complete”; “All complete or Verified Complete”; “45 Days Reminder”; “60 Days Reminder”; “Approaching”; “Overdue”; and “30 Days Overdue.” By selecting one or more of these filter criterion, the recommendation management logic module 132 will cull through only those stored recommendation entries that meet the defined criterion, and present only such entries. This filtering methodology is therefore a convenient way of allowing the user to focus their attention on certain recommendation entries that may require special attention for any reason or which are otherwise of particular interest.

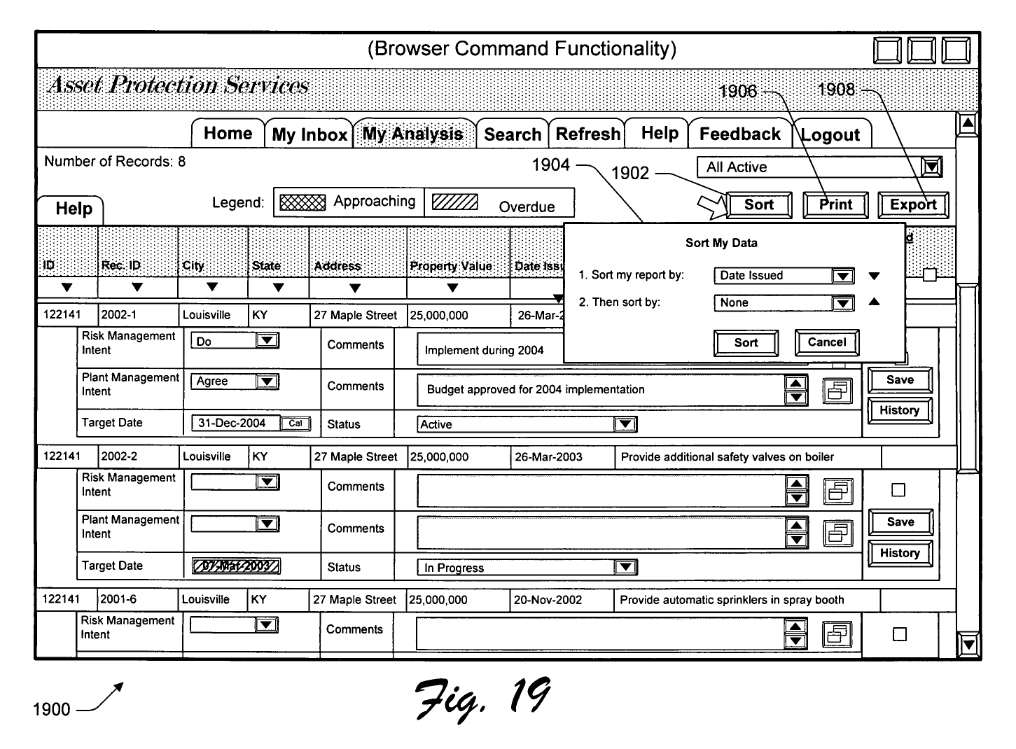

FIG. 19 shows another user interface presentation 1900 that demonstrates the use of sorting functionality provided by the recommendation management logic module 132. Namely, not only can the recommendation management logic module 132 cull out certain recommendation entries based on defined filter criteria, but it can also sort the entries that satisfy the filter criteria according to defined sorting criteria. To invoke this sorting mechanism, the user can activate the sort command button 1902. This activates a user interface panel 1904 that includes various sorting options. Namely, this interface panel 1904 gives the user the option of sorting according to a primary sorting criterion (e.g., such as sort by date issued) as well as a secondary sorting criterion. Each sorting criterion can be selected from a predefined group of possible sorting criteria entries. By virtue of this feature, the recommendation management logic module 132 can sort the recommendation entries into general buckets according to the primary sorting criterion, and then further arrange these recommendation entries within the buckets according to the secondary sorting criterion. This sorting strategy is exemplary; other techniques exist for receiving sorting instructions from the user and for subsequently executing the sorting operations.

The user interface presentation 1900 shown in FIG. 19 also demonstrates functionality that allows a user to print out the recommendation response report (e.g., in response to the activation of a command button 1906) and to export the recommendation response report (e.g., in response to the activation of command button 1908). The printed or exported recommendation response reports can be created based on specified filtering and sorting criteria described above.

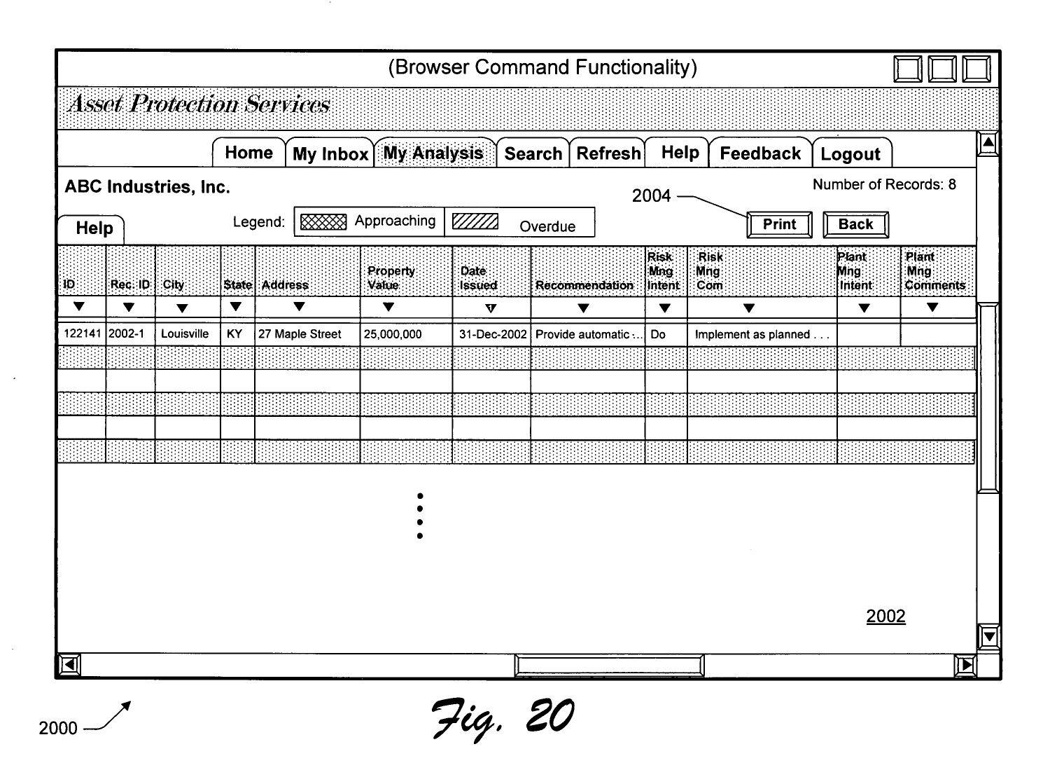

FIG. 20 shows a user interface presentation 2000 that illustrates a recommendation response report 2002 prepared in the above manner. Activation of the print command 2004 will prompt the recommendation management logic module 132 to print out the report 2002. Only one entry is shown in the report 2002 to simplify and facilitate discussion, but an actual report can include multiple entries (e.g., dozens, hundreds, etc.) arranged and sorted in a manner that has been selected by the user.

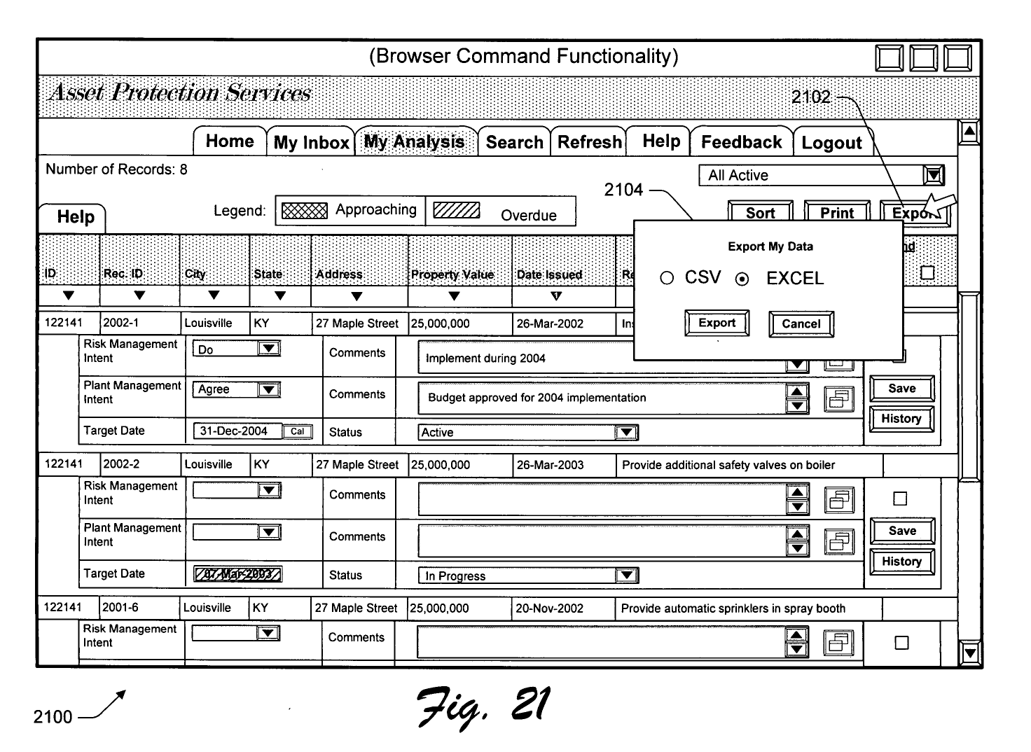

FIG. 21 shows a user interface presentation 2100 that demonstrates what happens when the user activates the export command button 2102. Namely, the recommendation management logic module 132 responds to this event by displaying the interface panel 2104. This interface panel 2104 gives the user the option of exporting the recommendation response report in a variety of formats, such as, in this exemplary case, a CSV format or an EXCEL format. In response to the exporting operation, information is extracted from the database 128 and compiled into a file that conforms to the format selected by the user.

Finally, FIG. 22 shows an exemplary user interface presentation 2200 that allows the user (such as a suitably authorized administrator) to customize the processing functionality 124 to suit the requirements of a particular business environment. Namely, this user interface page 2200 includes a number of customization options 2202 that define certain aspects of the user interface functionality described in FIGS. 6-21.

For instance, a first customization option 2204 gives the user the ability to determine whether the flow of the processing flow is to conform to the top-down approach, the bottom-up approach, or neither the top-down or bottom-up approaches (e.g., the “No workflow” approach). The previous discussion was predicated on the exemplary use of the top-down approach, but by selecting the second entry in this customization section 2204, the user interface functionality can be governed by the bottom-up approach, where plant-level individuals enter recommendation information first, followed by higher level overseeing managers (such as the risk manager 106). In the “No workflow” approach, either the risk manager 106 or the plant manager 108 can select their intent information first.

The second customization option 2206 gives the user the ability to define what phrases are used to capture the risk management intent information. The user is given the ability to choose from a standard list (e.g., corresponding to the model shown in the preceding figures, e.g., “Do,” “Do Alternate,” “Do Not Do,” “Hold,” “Consider,” etc.), and an alternative list (e.g., corresponding to selections of “Agree” and “Disagree”). Alternatively, the user can select his or her own set of custom phrases to be used via the custom list option. The risk management intent information can be customized using other selection strategies besides that shown in FIG. 22, such as by allowing the user to specify his or her own phrases (that do not necessary appear in a predetermined list of possible phrases).

The third customization option 2208 gives the user the ability to define what phrases are used to capture the plant management intent information. Again, the user is given the ability to choose from a standard list, an alternate list, and a custom list.

The fourth customization option 2210 gives the user the ability to define the behavior of the notification functionality. Namely, this customization option 2210 gives the user the ability to determine the timing at which the reminder notifications are sent out, as well as the recipient(s) for each reminder notification.

Still further customization options can be provided using the customization functionality shown in FIG. 22 or related functionality; the customization options shown in FIG. 22 are representative and exemplary.

For instance, customization functionality (e.g., as implemented by the service maintenance logic module 138 of FIG. 1) can be provided that allows an appropriately authorized user to customize the content and style of the various notifications (e.g., 134, 136) transmitted by the system 100. For instance, different client companies that utilize the system 100 may have different business cultures, and thus may have corresponding different preferences regarding the type of information that is conveyed by the notifications as well as the manner in which it is conveyed, including the phraseology and visual appearance of the notifications (generally referred to as “style” herein). The system 100 can allow appropriately authorized users to define this preference information and then store it in the system 100. The recommendation management logic module 132 can be configured to access and apply this information when sending notifications to users within a particular business environment. Recipients in that business environment would therefore receive notifications that are specifically tailored to their own business environment and culture.

The service maintenance logic 138 can also allow appropriately authorized users to customize any other above-described aspect of the system 100 to suit the needs of specific users. For instance, the service maintenance logic 138 can uniquely tailor any aspect of the user interface functionality to best suit the preferences of individual clients.

In closing, systems and techniques were described for developing recommendations. These systems and techniques offer several benefits. According to one exemplary benefit, a system is provided that allows a field consultant to enter data directly into a database, and this data can then be used to construct a recommendation response report. Therefore, it is not necessary to re-key this data from paper reports prepared by the field consultant. This procedure is therefore less burdensome and more error-proof than techniques that require such re-keying.

According to another benefit, a system is provided that employs a well-defined process flow for collecting information from actors involved in the development of recommendations, and for facilitating interaction between these actors. A graphical user interface is built around this structured process and is integrated with this process. This feature assists these actors in understanding their roles, such as in understanding the nature of the information that they are required to provide, and in understanding when they should provide it. This eliminates some of the confusion and inefficiencies common in ad hoc approaches to developing recommendations.

According to another benefit, the system provides helpful reminder notifications. Namely, this functionality sends out a plurality of reminder notifications at different times, triggered by different timing conditions, and sent to different appropriate participants. This functionality better ensures that the participants will not forget about action items, and that recommendation projects will not become bottlenecked due to tardy and ill-timed responses from participants.

According to another benefit, the system integrates recommendation information collected according to the above-described process flow with various analysis tools, such as prediction tools. This allows the users to quickly and efficiently gain insight into the nature of the business by applying these tools to the collected data.

According to another benefit, the system provides a variety of tools for filtering, sorting, printing, and exporting recommendation entries. This better ensures that the information collected in the above-described manner is presented in the most useful form.

According to another benefit, the system provides unique color coding (or other visible attribute coding) to highlight action items with heightened urgency associated therewith.

According to another benefit, the system provides customization functionality that allows administrators to quickly and easily tailor the behavior of the system to different business environments. For instance, the customization functionality can customize the flow methodology that is applied to the system, the specific phraseology used to express various instructions and status information, the reminder notification behavior, and so on.

Still other benefits are achieved using the above-described techniques and systems. The above-described benefits are exemplary.

A number of examples were presented in this disclosure in the alternative (e.g., case X or case Y). In addition, this disclosure encompasses those cases which combine alternatives in a single implementation (e.g., case X and case Y), even though this disclosure may have not expressly mentioned these conjunctive cases in every instance.

More generally, although the invention has been described in language specific to structural features and/or methodological acts, it is to be understood that the invention defined in the appended claims is not necessarily limited to the specific features or acts described. Rather, the specific features and acts are disclosed as exemplary forms of implementing the claimed invention.

1. A method for managing recommendations using a computer system, comprising:
receiving survey information from an individual serving a first role pertaining to an aspect of an organizational entity, the survey information including at least one recommendation;
storing the survey information;
receiving, via a user interface, first recommendation information from an individual serving a second role, the first recommendation information being based on the survey information received from the individual serving the first role;
storing the recommendation information;
receiving, via the user interface, second recommendation information from an individual serving a third role, the second recommendation information being based on the first information received from the individual serving the second role;
storing the second recommendation information; and
addressing said at least one recommendation based on the first and second recommendation information.

2. The method according to claim 1, wherein the individual serving the first role, the individual serving the second role, and the individual serving the third role are different individuals.

3. The method according to claim 1, wherein the individual serving the first role is a field consultant who serves the role of inspecting the organizational entity to determine whether it satisfies a defined criterion.

4. The method according to claim 3, wherein the defined criterion pertains to safeguards against property loss within the organizational entity, and said at least one recommendation pertains to a measure designed to reduce property loss.

5. The method according to claim 1, wherein the individual serving the second role is a risk manager who serves the role of evaluating and addressing risk-related issues associated with the organizational entity.

6. The method according to claim 1, wherein the individual serving the second role is a facility manager who serves the role of coordinating the implementation of risk-reduction measures within a facility.

7. The method according to claim 1, wherein the individual serving the third role is a risk manager who serves the role of evaluating and addressing risk-related issues associated with the organizational entity.

8. The method according to claim 1, wherein the individual serving the third role is a facility manager who serves the role of coordinating the implementation of risk-reduction measures within a facility.

9. The method according to claim 1, wherein the organizational entity is a business having multiple facilities.

10. The method according to claim 1, wherein the receiving of the first recommendation information from the individual serving the second role and the receiving of second recommendation information from the individual serving the third role comprises sequentially providing a recommendation response report to the individual serving the second role and then to the individual serving the third role via the user interface, wherein the recommendation response report includes input fields for receiving the first recommendation information from the individual serving the second role and from the second recommendation information from the individual serving the third role.

11. The method according to claim 10, wherein the user recommendation report includes a first section for receiving the first recommendation information from the individual serving the second role and a second section for receiving the second recommendation information from the individual serving the second role.

12. The method according to claim 1, wherein the receiving of first recommendation information from the individual serving the second role comprises receiving at least one of: intent information which conveys instructions of the individual serving the second role; and comment information provided by the individual serving the second role.

13. The method according to claim 1, wherein the receiving of second recommendation information from the individual serving the third role comprises receiving at least one of: intent information which conveys the response of the individual serving the third role to instructions of the individual serving the second role; and comment information provided by the individual serving the third role.

14. The method according to claim 1, further including receiving a target date associated with the implementation of said at least one recommendation.

15. The method according to claim 14, further including receiving status information pertaining to the target date.

16. The method according to claim 1, wherein the user interface includes at least one field having a visual attribute that conveys a level of urgency associated with said at least one field.

17. The method according to claim 16, wherein said at least one field pertains to a target date field, and the visual attribute is color.

18. The method according to claim 1, further including sending a notification from the individual serving the second role to at least the individual serving the third role after the first recommendation information is received from the individual serving the second role.

19. The method according to claim 1, further including sending a reminder notification to at least the individual serving the third role if the individual serving the third role fails to enter the second recommendation information within a predetermined period of time.

20. The method according to claim 19, wherein the predetermined period of time is measured with respect to a time when the individual serving the second role entered the recommendation information.

21. The method according to claim 19, wherein the predetermined period of time is measured with respect to a specified target date pertaining to the implementation of said at least one recommendation.

22. The method according to claim 19, further including sending another reminder notification if the individual serving the third role fails to respond to the first-mentioned reminder notification, the other reminder notification conveying greater urgency compared to the first-mentioned reminder notification.

23. The method according to claim 19, further including customizing at least one of: a timing at which the reminder notification is to be transmitted; an identity of at least one recipient who is to receive the reminder notification; information content of the reminder notification; and a style of the reminder notification.

24. The method according to claim 1, wherein, in a top-down mode of process flow, the individual serving the second role serves an overseeing role with respect to the individual serving the third role.

25. The method according to claim 1, wherein, in a bottom-up mode of process flow, the individual serving the third role serves an overseeing role with respect to the individual serving the second role.

26. The method according to claim 1, wherein, in a top-down mode of process flow, the individual serving the second role serves an overseeing role with respect to the individual serving the third role, and, in a bottom-up mode of process flow, the individual serving the third role serves an overseeing role with respect to the individual serving the second role, and, in a no-flow mode of process flow, either the individual serving the second role or the individual serving the third role can enter recommendation information first, and the method further includes allowing a user to define whether the method is to operate in the top-down mode or the bottom-up mode or a no-flow mode.

27. The method according to claim 1, further including providing a listing that identifies a historical sequence of information entered by the individual serving the first role, the individual serving the second role, and the individual serving the third role.

28. The method according to claim 1, further including filtering received survey information and recommendation information based on at least one selected criterion.

29. The method according to claim 1, further including sorting received survey information and recommendation information based on at least one selected criterion.

30. The method according to claim 1, further including printing received survey information and recommendation information in a selected report format.

31. The method according to claim 1, further including exporting received survey information and recommendation information into a selected export file format.

32. A computer readable medium including machine readable instructions for implementing the method of claim 1.

33. A recommendation management module for managing recommendations, comprising:
logic configured to receive survey information from an individual serving a first role pertaining to an aspect of an organizational entity, the survey information including at least one recommendation;
logic configured to store the survey information;
logic configured to receive, via a user interface, first recommendation information from an individual serving a second role, the first recommendation information being based on the survey information received from the individual serving the first role;
logic configured to store the first recommendation information;
logic configured to receive, via the user interface, second recommendation information from an individual serving a third role, the second recommendation information being based on the first recommendation information received from the individual serving the second role; and
logic configured to store the second recommendation information.

34. The recommendation management module according to claim 33, wherein the individual serving the first role, the individual serving the second role, and the individual serving the third role are different individuals.

35. The recommendation management module according to claim 33, wherein the logic for receiving the first recommendation information from the individual serving the second role and the logic for receiving the second recommendation information from the individual serving the third role comprises logic configured to sequentially provide a recommendation response report to the individual serving the second role and then to the individual serving the third role via the user interface, wherein the recommendation response report includes input fields for receiving the first recommendation information from the individual serving the second role and the second recommendation information from the individual serving the third role.

36. The recommendation management module according to claim 35, wherein the recommendation response report includes a first section for receiving the first recommendation information from the individual serving the second role and a second section for receiving the second recommendation information from the individual serving the third role.

37. The recommendation management module according to claim 33, wherein the logic for receiving the first recommendation information from the individual serving the second role is configured to receive at least one of: intent information which conveys instructions of the individual serving the second role; and comment information provided by the individual serving the second role.

38. The recommendation management module according to claim 33, wherein the logic for receiving the second recommendation information from the individual serving the third role is configured to receive at least one of: intent information which conveys the response of the individual serving the third role to instructions of the individual serving the second role; and comment information provided by the individual serving the third role.

39. The recommendation management module according to claim 33, further including logic configured to receive a target date associated with the implementation of said at least one recommendation.

40. The recommendation management module according to claim 39, further including logic configured to receive status information pertaining to the target date.

41. The recommendation management module according to claim 33, wherein the user interface includes at least one field having a visual attribute that conveys a level of urgency associated with said at least one field.

42. The recommendation management module according to claim 41, wherein said at least one field pertains to a target date field, and the visual attribute is color.

43. The recommendation management module according to claim 33, further including logic configured to send a notification from the individual serving the second role to at least the individual serving the third role after the first recommendation information is received from the individual serving the second role.

44. The recommendation management module according to claim 33, further including logic configured to send a reminder notification to at least the individual serving the third role if the individual serving the third role fails to enter the second recommendation information within a predetermined period of time.

45. The recommendation management module according to claim 44, wherein the predetermined period of time is measured with respect to a time when the individual serving the second role entered the first recommendation information.

46. The recommendation management module according to claim 44, wherein the predetermined period of time is measured with respect to a specified target date pertaining to the implementation of said at least one recommendation.

47. The recommendation management module according to claim 44, wherein logic for sending a reminder notification is further configured to send another reminder notification if the individual serving the third role fails to respond to the first-mentioned reminder notification, the other reminder notification conveying greater urgency compared to the first-mentioned reminder notification.

48. The recommendation management module according to claim 44, further including logic configured to customize at least one of: a timing at which the reminder notification is to be transmitted; an identity of at least one recipient who is to receive the reminder notification; information content of the reminder notification; and a style of the reminder notification.

49. The recommendation management module according to claim 33, wherein, in a top-down mode of process flow, the individual serving the second role serves an overseeing role with respect to the individual serving the third role, and, in a bottom-up mode of process flow, the individual serving the third role serves an overseeing role with respect to the individual serving the second role, and, in a no-flow mode of process flow, either the individual serving the second role or the individual serving the third role can enter recommendation information first, and the recommendation management module further includes logic configured to allow a user to define whether a process flow is to operate in the top-down mode or the bottom-up mode or the no-flow mode.

50. The recommendation management module according to claim 33, further including logic configured to provide a listing that identifies a historical sequence of recommendation information received from the individual serving the first role, the individual serving the second role, and the individual serving the third role.

51. The recommendation management module according to claim 33, further including logic configured to filter received survey information and recommendation information based on at least one selected criterion.

52. The recommendation management module according to claim 33, further including logic configured to sort received survey information and recommendation information based on at least one selected criterion.

53. The recommendation management module according to claim 33, further including logic configured to print received survey information and recommendation information in a selected report format.

54. The recommendation management module according to claim 33, further including logic configured to export received survey information and recommendation information into a selected export file format.

55. A computer readable medium including machine readable instructions for implementing recommendation management module of claim 33.

56. A system for managing recommendations using a computer system, comprising:
a plurality of computer devices available to an individual serving a first role, an individual serving a second role, and an individual serving a third role;
processing functionality communicatively coupled to the plurality of computer devices via a network, wherein the processing functionality includes:
a database storage;
a recommendation management module including:
logic configured to receive, via one of the computer devices, survey information from the individual serving the first role pertaining to an aspect of an organizational entity, the survey information including at least one recommendation;
logic configured to store the survey information in the database storage;
logic configured to receive, via a user interface provided on one of the computer devices, first recommendation information from the individual serving the second role, the recommendation information being based on the survey information received from the individual serving the first role;
logic configured to store the first recommendation information in the database storage;
logic configured to receive, via the user interface provided on one of the computer devices, second recommendation information from the individual serving the third role, the second recommendation information being based on the first recommendation information received from the individual serving the second role; and
logic configured to store the second recommendation information in the database storage.

57. The system according to claim 56, wherein the individual serving the first role, the individual serving the second role, and the individual serving the third role are different individuals.

58. A computer device for presenting a user interface display for managing recommendations, comprising:
logic configured to present a first input section dedicated to receiving first recommendation information from an individual serving a first role;
logic configured to receive the first recommendation information from the individual serving the first role;
logic configured to present a second input section dedicated to receiving second recommendation information from an individual serving a second role; and
logic configured to receive the second recommendation information from the individual serving the second role.

59. The computer device according to claim 58, wherein the individual serving the first role and the individual serving the second role are different individuals.

60. The computer device according to claim 58, wherein the logic for presenting the first input section and the logic for presenting the second input section are configured to present a recommendation response report including the first section and second section as parts thereof.

61. The computer device according to claim 58, wherein the first section includes input fields for receiving at least one of: intent information which conveys instructions of the individual serving the first role; and comment information provided by the individual serving the first role.

62. The computer device according to claim 58, wherein the second section includes input fields for receiving at least one of: intent information which conveys a response of the individual serving the second role to instructions of the individual serving the first role; and comment information provided by the individual serving the second role.

63. The computer device according to claim 58, wherein the second section includes an input field for receiving a target date which conveys a date associated with the implementation of a recommendation.

64. The computer device according to claim 63, wherein second section further includes an input field for receiving status information pertaining to the target date.

65. The computer device according to claim 63, wherein the target date includes a visual attribute that conveys a level of urgency associated with the target date.

66. The computer device according to claim 65, wherein the visual attribute is color.

67. The computer device according to claim 58, further including logic configured to display a listing that identifies a historical sequence of recommendation information entered by the individual serving the first role and the individual serving the second role.

68. A computer readable medium including machine readable instructions for implementing each of the logic of claim 58.
